(19) United States
(12) Patent Application Publication
(10) Pub. No.: US 2017/0371452 A1
(43) Pub. Date: Dec. 28, 2017

(54) TOUCH SENSOR AND TOUCH PANEL

(71) Applicant: FUJIFILM CORPORATION, Tokyo (JP)

(72) Inventors: Yasushi ENDO, Kanagawa (JP); Nobuyuki TADA, Kanagawa (JP)

(73) Assignee: FUJIFILM CORPORATION, Tokyo (JP)

(21) Appl. No.: 15/681,849

(22) Filed: Aug. 21, 2017

Related U.S. Application Data
(63) Continuation of application No. PCT/JP2016/055084, filed on Feb. 22, 2016.

(30) Foreign Application Priority Data
Mar. 27, 2015 (JP) 2015-067252

(51) Int. Cl. G06F 3/044; H01Q 1/52; H01Q 1/24

(52) U.S. Cl. CPC G06F 3/044; H01Q 1/526; G06F 2203/04112; G06F 2203/04107; H01Q 1/24

(57) ABSTRACT

A touch sensor has one substrate having a plurality of regions that are at least a planar region and a side surface region which is continuous to the planar region and is bent with respect to the planar region, a touch sensor portion provided in the planar region of the substrate, and an antenna provided in a region other than the planar region of the substrate. The substrate is constituted of a flexible transparent substrate. The touch sensor portion includes a detection portion and a peripheral wire portion, and at least the detection portion is constituted of a thin metal wire.

### CROSS-REFERENCE TO RELATED APPLICATIONS

This application is a Continuation of PCT International Application No. PCT/JP2016/055084 filed on Feb. 22, 2016, which claims priority under 35 U.S.C. §119(a) to Japanese Patent Application No. 2015-067252 filed on Mar. 27, 2015. The above application is hereby expressly incorporated by reference, in its entirety, into the present application.

### BACKGROUND OF THE INVENTION

### 1. Field of the Invention

The present invention relates to a touch sensor that can be used together with display devices such as liquid crystal display devices and a touch panel in which the touch sensor is used and particularly to a touch sensor including an antenna and a touch panel in which the touch sensor including an antenna is used.

### 2. Description of the Related Art

At the moment, for mobile terminal devices equipped with touch panels which are called smartphones, tablets, or the like, efforts are being made to improve the functions and reduce the size, thickness, and weight. These mobile terminal devices are equipped with a plurality of antennas such as a telephone antenna, a wireless fidelity (WiFi) antenna, and a Bluetooth (registered trademark) antenna.

For example, JP3171994Y describes a polyfunctional touch panel having a transparent touch sensor and a planar antenna. The planar antenna is provided at the outer circumferential edge of the touch sensor.

In addition, in the power-receiving device of JP2012-213251A, a resistance film-mode touch panel having a mobile transparent electrode film and a fixed transparent electrode film is provided, and a control portion is constituted so as to selectively switch and control a position detection circuit that detects contact positions in the touch panel and a power-receiving, circuit that supplies power received by a mobile transparent electrode as an electric field coupling-mode power-receiving electrode to secondary batteries. In a power transmission system, a power-transmitting device having a power-transmitting electrode which has a power-receiving device mounted therein and transmits power in an electric field coupling mode using the mobile transparent electrode film as a power-receiving electrode is provided.

### SUMMARY OF THE INVENTION

In a case in which a mobile terminal device including a touch panel is equipped with antennas as described above, in order to maintain the antenna performance, the antennas desirably have an antenna length that relies on the wavelengths of communication frequencies. Since the mobile terminal device has a structure in which an antenna module is separately prepared and a built-in substrate and the antenna module are connected with each other using a cable, it is not always true that the optimal antenna module installation space can be secured. In addition, the antenna module has a structure that becomes complicated depending on limited spaces, and thus it is difficult to reduce the costs. Meanwhile, as means for equipping the built-in substrate with antenna functions, there is a method in which a small-size chip antenna to which a dielectric body or the like is combined is used; however, in a case in which the small-size chip antenna is used, the antenna size is small, and the radiation efficiency of the antenna deteriorates. In addition, there is a disadvantage of the necessity for adding accessory components or the like.

Furthermore, in a case in which a mobile terminal device including a touch panel is equipped with antennas, spaces are required to provide the antennas, and it is difficult to slim the bezel of the touch panel or reduce the size of the mobile terminal device.

An object of the present invention is to solve the above-described problems based on the related art and provide a touch sensor which enables a simplified constitution, a reduced size, and, furthermore, a reduced cost and a touch panel in which the touch sensor is used.

In order to achieve the above-described object, a first aspect of the present invention provides a touch sensor comprising: a substrate having a plurality of regions that are at least a planar region and a side surface region which is continuous to the planar region and is bent with respect to the planar region; a touch sensor portion provided in the planar region of the substrate; and an antenna provided in a region other than the planar region of the substrate, in which the substrate is constituted of a flexible transparent substrate, the touch sensor portion includes a detection portion and a peripheral wire portion, and at least the detection portion is constituted of a thin metal wire.

The antenna is preferably provided in the side surface region. In addition, the substrate is preferably provided with a shield portion that shields electromagnetic noise travelling toward at least one of the touch sensor portion or the antenna.

It is preferable that the substrate includes another planar region which is continuous to the planar region or the side surface region, and the shield portion that shields electromagnetic noise travelling toward at least one of the touch sensor portion or the antenna is provided in the another planar region.

The touch sensor portion and the antenna are preferably constituted of the same material. In addition, the touch sensor portion, the antenna, and the shield portion are preferably constituted of the same material.

A surface resistance of the same material is preferably 3 Ω/sq. or less. For example, the same material is copper.

In addition, it is preferable that a width of the thin metal wire in the detection portion in the touch sensor portion is 5 μm or less and a pattern width in the antenna is 150 μm or more.

It is preferable that the detection portion in the touch sensor portion and the antenna are constituted of the thin metal wire, and the thin metal wire has a width of 5 μm or less.

A second aspect of the present invention is to provide a touch panel module comprising: the touch sensor of the first aspect of the present invention.

According to the touch sensor of the present invention and the touch panel in which the touch sensor is used, it is possible to reduce the size by simplifying the constitution and decreasing the number of components and to reduce the thickness and weight and slim the bezel. In addition, since the number of components can be decreased, the cost can also be reduced.

### BRIEF DESCRIPTION OF THE DRAWINGS

FIG. 1 is a perspective view illustrating an electronic device including a touch panel of a first embodiment of the present invention.

FIG. 2 is a cross-sectional view in a direction of A-A line in FIG. 1.

FIG. 3 is a schematic plan view illustrating the touch panel of the first embodiment of the present invention.

FIG. 4 is a schematic cross-sectional view illustrating an example of a three-dimensional shape of the touch panel of the first embodiment of the present invention.

FIG. 5 is a schematic cross-sectional view illustrating another example of a three-dimensional shape of the touch panel of the first embodiment of the present invention.

FIG. 6 is a cross-sectional view of a main portion in FIG. 1.

FIG. 7 is a plan view illustrating an example of a conductive pattern formed of a thin metal wire.

FIG. 8 is a schematic view illustrating an example of an antenna.

FIG. 9 is a schematic view illustrating an example of an electric conductor constituting the antenna.

FIG. 10 is a schematic view illustrating another example of the electric conductor constituting the antenna.

FIG. 11 is a schematic plan view illustrating a touch panel of a second embodiment of the present invention.

FIG. 12 is a schematic cross-sectional view illustrating an electronic device including the touch panel of the second embodiment of the present invention.

FIG. 13 is a schematic view illustrating an example of an antenna.

FIG. 14 is a schematic plan view illustrating a touch panel of a third embodiment of the present invention.

FIG. 15 is a schematic plan view illustrating a touch panel of a fourth embodiment of the present invention.

FIG. 16 is a cross-sectional view of a main portion illustrating a touch panel of a fifth embodiment of the present invention.

FIG. 17 is a cross-sectional view of a main portion illustrating a modification example of the touch panel of the fifth embodiment of the present invention illustrated in FIG. 16.

FIG. 18 is a cross-sectional view of a main portion illustrating a touch panel of a sixth embodiment of the present invention.

FIG. 19 is a cross-sectional view of a main portion illustrating a first modification example of the touch panel of the sixth embodiment of the present invention.

FIG. 20 is a cross-sectional view of a main portion illustrating a second modification example of the touch panel of the sixth embodiment of the present invention.

### DESCRIPTION OF THE PREFERRED EMBODIMENTS

Hereinafter, a touch sensor and a touch panel of the present invention will be described in detail on the basis of preferred embodiments illustrated in the accompanying drawings.

Meanwhile, in the following description, numerical ranges expressed using “to” include numerical values on both sides of the “to”. For example, ε being a numerical value α to a numerical value β means that the range of ε is a range including the numerical value α and the numerical value β and is expressed by a mathematical sign of α≦ε≦β.

Being both optically transparent and simply transparent means that, in a visible light wavelength range of 400 to 800 nm, the light transmittance is at least 60% or higher, preferably 75% or higher, more preferably 80% or higher, and still more preferably 85% or higher.

The light transmittance is measured using, for example, “Plastics Determination of total luminous transmittance and reflectance” prescribed by JIS K 7375:2008.

Thin metal wires have a composition that is constituted of a single metal element or a plurality of metal elements and have a content of oxides that is less than 20% by mass. Thin metal wires constituted of a plurality of metal elements may be alloys or thin metal wires in which a plurality of kinds of metal are present independently from each other. In addition, the thin metal wires are not limited to thin metal wires constituted of metal elements alone and may be thin metal wires having metal particles and binders as described below. The metal particles may be particles constituted of a single metal element or alloys made up of a plurality of metal elements. In addition, a plurality of kinds of metal particles that are constituted of a single metal element may be present. Conductive oxides such as indium tin oxide (ITO) and conductive resins and the like are not considered as the thin metal wires.

The same material refers to a group of materials having the same kinds and contents of compositional components. In this case, the kinds of compositional components need to be identical, but the contents may have a margin of ±10%. In addition, for example, products formed of the same material by the same step are referred to as the material.

The composition and content of thin metal wires can be measured using, for example, fluorescent X-ray analyzers.

Next, a touch panel of a first embodiment of the present invention will be described.

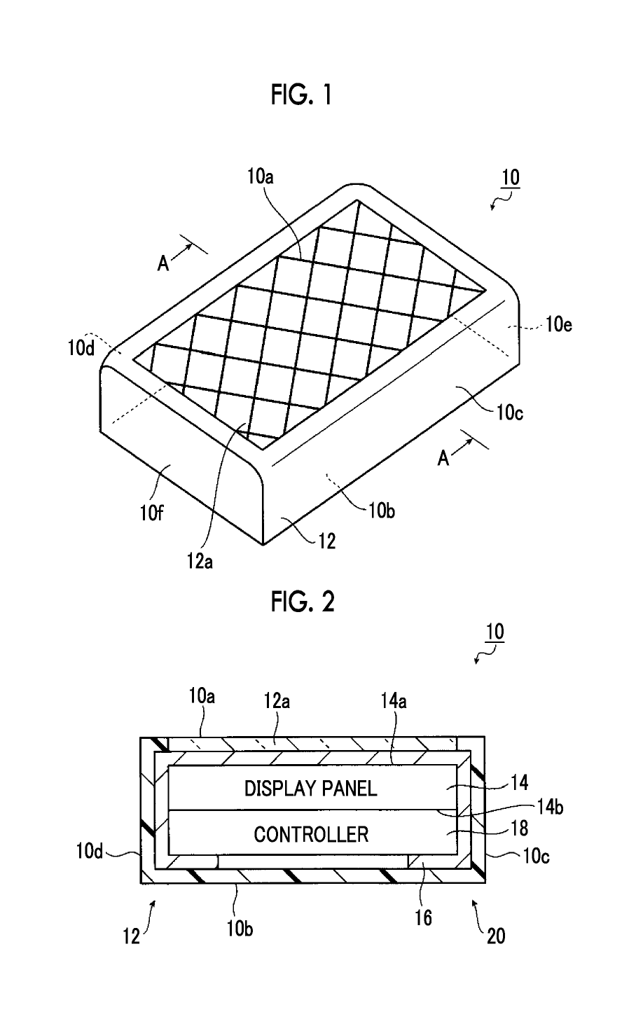

FIG. 1 is a perspective view illustrating an electronic device including the touch panel of the first embodiment of the present invention, and FIG. 2 is a cross-sectional view in a direction of A-A line in FIG. 1.

An electronic device 10 illustrated in FIG. 1 and FIG. 2 has a three-dimensional shape and has a touch panel 20 of an embodiment of the present invention therein.

The electronic device 10 includes a chassis 12 having a three-dimensional shape which constitutes the outer form, and a display panel 14, a touch sensor 16, and a controller 18 are provided in the chassis 12. The touch sensor 16 is disposed on a display surface 14a of the display panel 14. While described in detail below, the touch sensor 16 has a three-dimensional shape. The controller 18 is provided on a rear surface 14b of the display panel 14. A touch panel 20 having a three-dimensional shape is constituted of the touch sensor 16 and the controller 18.

In the electronic device 10, for example, a front surface 10a serves as the display surface. In the chassis 12, an optically transparent region 12a is provided in order to recognize images that are displayed on the display panel 14. The front surface 10a of the electronic device 10 is also referred to as the main surface. The electronic device 10 has the front surface 10a which is the main surface, the rear surface 10b which faces the front surface 10a, and four side surfaces 10c to 10f adjacent to the front surface 10a.

The display panel 14 is not particularly limited as long as the display panel is capable of displaying images including still images, moving images, and the like on the display surface 14a, and it is possible to use, for example, liquid crystal display devices, organic electro-luminescence (EL) display devices, electronic paper, and the like.

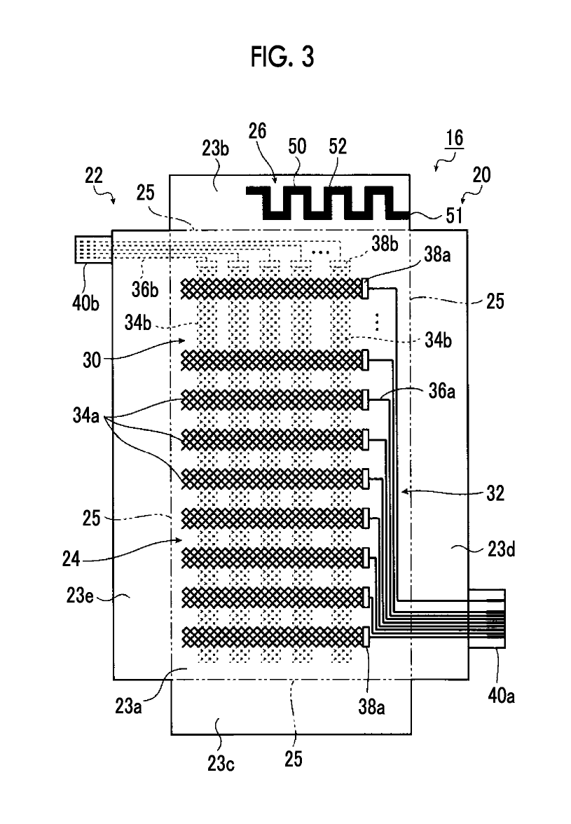

The controller 18 has control circuits (not illustrated) that control the display panel 14, control the touch sensor 16, and control data communication through an antenna 26 (refer to FIG. 3) described below. The control circuits are constituted of, for example, electronic circuits.

In a case in which a touch sensor portion 24 (refer to FIG. 3), which will be described in detail below, in the touch sensor 16 is touched by a finger, in the case of an electrostatic capacitance type, a change in the electrostatic capacitance is caused at the touched position, the controller 18 detects this change in the electrostatic capacitance, and the coordinate of the touched position is specified. The controller 18 is constituted of a well-known ordinary controller which is used for the position detection of ordinary touch panels. Meanwhile, in the case of an electrostatic capacitance-type touch sensor 16, electrostatic capacitance-type control circuits are used. In addition, in the case of a resistance film-type touch sensor 16, resistance film-type control circuits are appropriately used.

In addition, in the controller 18, as the control circuit for controlling the display panel 14 and the control circuit for controlling data communication, well-known control circuits can be appropriately used.

The chassis 12 constitutes the outer form of the electronic device 10, is intended to maintain the three-dimensional shape of the electronic device 10, and is formed in a three-dimensional shape. The material and the like constituting the chassis 12 are not particularly limited, and the chassis is constituted of, for example, a resin material. The chassis 12 may have a monolayer structure or a multilayer structure.

In the chassis 12, for example, the optically transparent region 12a as described above is provided, and this region 12a may be constituted of an optically transparent material or may be simply an opening portion.

Hereinafter, the touch sensor 16 and the touch panel 20 will be described in detail.

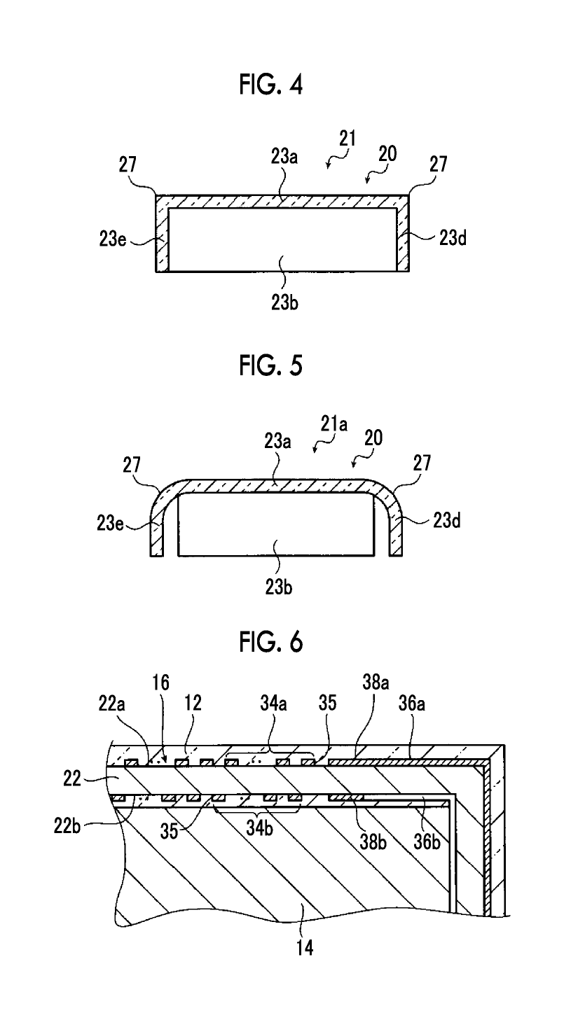

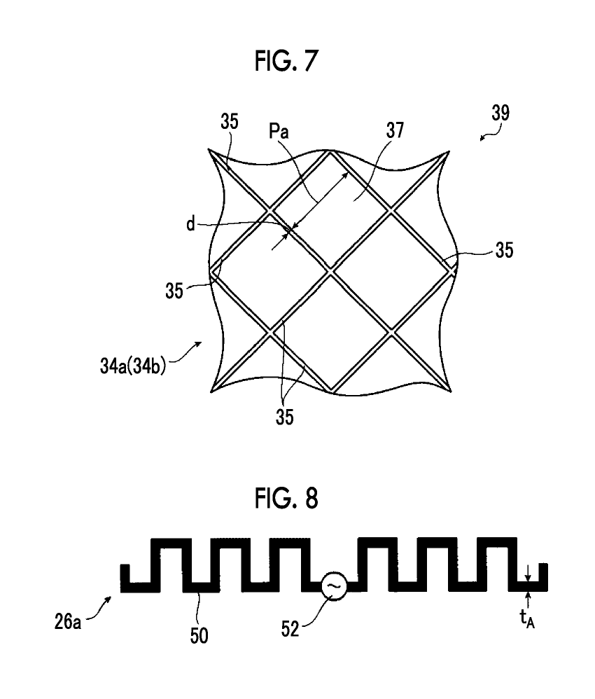

FIG. 3 is a schematic plan view illustrating the touch panel of the first embodiment of the present invention, FIG. 4 is a schematic cross-sectional view illustrating an example of the three-dimensional shape of the touch panel of the first embodiment of the present invention, FIG. 5 is a schematic cross-sectional view illustrating another example of the three-dimensional shape of the touch panel of the first embodiment of the present invention. FIG. 6 is a cross-sectional view of a main portion in FIG. 1, and FIG. 7 is a plan view illustrating an example of a conductive pattern formed of a thin metal wire.

In FIG. 3, the touch sensor 16 is illustrated in a planar manner in order to facilitate the understanding of the disposition of the respective portions; however, as described above, in the touch sensor 16, a substrate 22 is formed in a three-dimensional shape by means of, for example, a bending process.

As illustrated in FIG. 3, the touch sensor 16 has the substrate 22 having a three-dimensional shape, the touch sensor portion 24, and the antenna 26, and the touch sensor portion 24 and the antenna 26 are provided on one substrate 22.

Meanwhile, the mode of the touch sensor 16 is not particularly limited, and a projection-type electrostatic capacitance-mode touch sensor, a surface-type electrostatic capacitance-mode touch sensor, a resistance film-type touch sensor, or the like can be constituted. The touch sensor 16 can be provided with constitutions suitable for a variety of modes described above.

The substrate 22 is constituted of a flexible transparent substrate and is formed in a three-dimensional shape. Specific examples of the flexible transparent substrate will be described below. Meanwhile, the flexible substrate means that the substrate is workable enough to form the electronic device 10 having a three-dimensional shape as illustrated in FIG. 1.

The substrate 22 has a plurality of regions and includes at least a planar region 23a and side surface regions 23b to 23e which are continuous to the planar region 23a and are bent with respect to the planar region 23a. In FIG. 3, one planar region 23a and four side surface regions 23b to 23e are provided. The planar region 23a is disposed on the display surface 14a of the above-described display panel 14. The display surface 14a of the display panel 14 and the planar region 23a of the substrate 22 are disposed at a position corresponding to the main surface of the electronic device 10.

Since the substrate 22 is constituted of a flexible transparent substrate as described above, it is possible to bend the four side surface regions 23b to 23e at the circumferential edge 25 of the planar region 23a as a boundary. Therefore, for example, a structure 21 having a three-dimensional shape as illustrated in FIG. 4 is formed. In the structure 21 having a three-dimensional shape of FIG. 4, a corner portion 27 among the planar region 23a and the side surface regions 23b and 23e is formed by bending the side surface regions and thus has a small curvature, but the corner portion is not limited thereto. Like a structure 21a having a three-dimensional shape illustrated in FIG. 5, the three-dimensional shape may be provided by forming the corner portion 27 in a curved shape at a large curvature. The shapes of the structures 21 and 21a having a three-dimensional shape are appropriately determined depending on the limitations in the functions of the electronic device 10, designs, and the like.

Meanwhile, the substrate 22 is provided with a three-dimensional shape by bending the side surface regions 23b to 23e, but the method for forming the side surface regions 23b to 23e is not limited to bending as long as the substrate 22 can be provided with a three-dimensional shape.

In a case in which the antenna 26 and a peripheral wire portion 32, which will be described below, are not provided in the side surface regions 23b to 23e due to the limitations in the specification or design of the electronic device 10, it is not necessary to provide the four side surface regions 23b to 23e at all times. For example, in FIG. 3, there is nothing formed in the side surface region 23c out of the side surface regions 23b to 23e. Therefore, the side surface region 23c may not be provided. In addition, the side surface region 23c in which nothing is formed may be cut after the formation of the antenna 26 and the peripheral wire portion 32. The number of the side surface regions is not particularly limited as long as the substrate 22 can be provided with a three-dimensional shape.

As illustrated in FIG. 3, the touch sensor portion 24 is provided in the planar region 23a. One antenna 26 is provided in one side surface region 23b.

The touch sensor portion 24 includes a detection portion 30 and the peripheral wire portion 32, and at least the detection portion 30 is constituted of a thin metal wire 35 (refer to FIG. 7).

The detection portion 30 has a plurality of first sensing electrodes 34a and a plurality of second sensing electrodes 34b. The first sensing electrodes 34a are disposed in parallel at intervals, for example, in a direction toward the side surface region 23b from the side surface region 23c (hereinafter, also referred to as the first direction). The second sensing electrodes 34b are disposed in parallel at intervals, for example, in a direction toward the side surface region 23d from the side surface region 23e (hereinafter, also referred to as the second direction).

As illustrated in FIG. 6, the first sensing electrodes 34a are formed on the planar region 23a on a front surface 22a of the substrate 22. The second sensing electrodes 34b are formed on the planar region 23a on a rear surface 22b of the substrate 22. Meanwhile, the antenna 26 is also formed in the side surface region 23b on the front surface 22a of the substrate 22, and the first sensing electrodes 34a and the antenna 26 are formed on the same surface.

In a case in which the first sensing electrodes 34a and the second sensing electrodes 34b are formed on the front surface 22a and the rear surface 22b of one substrate 22 respectively, it is possible to alleviate the deviation of the positional relationship between the first sensing electrodes 34a and the second sensing electrodes 34b even in a case in which the substrate 22 expands or contracts.

Meanwhile, a protective layer (not illustrated) for protecting the first sensing electrodes 34a and the like and a protective layer (not illustrated) for protecting the second sensing electrodes 34b may be provided on the front surface 22a and the rear surface 22b of the substrate 22 respectively. The protective layers can be formed using, for example, glass, polycarbonate (PC), polyethylene terephthalate (PET), optically transparent pressure-sensitive adhesives called optically clear adhesives (OCA), optically transparent resins such as ultraviolet-curable resins called optically clear resins (OCR), or the like. Furthermore, a hardcoat layer, an antireflection layer, or the like may be provided on the surface of the protective layer.

First wire connection portions 38a electrically connected to the end portions of the respective first sensing electrodes 34a are provided. First terminal wire portions 36a are electrically connected to the first wire connection portions 38a.

The respective first terminal wire portions 36a derived from the respective first wire connection portions 38a are extracted toward the side surface region 23d and are electrically connected to respectively corresponding first terminal portions 40a.

Second wire connection portions 38b electrically connected to the end portions of the respective second sensing electrodes 34b are provided. Second terminal wire portions 36b are electrically connected to the second wire connection portions 38b.

The respective second terminal wire portions 36b derived from the respective second wire connection portions 38b are extracted toward the side surface region 23e and are electrically connected to respectively corresponding second terminal portions 40b.

The peripheral wire portion 32 is constituted of the first terminal wire portions 36a, the first terminal portions 40a, the second terminal wire portions 36b, and the second terminal portion 40b.

The first terminal portions 40a and the second terminal portions 40b are electrically connected to the controller 18 (refer to FIG. 2) using, for example, a connector (not illustrated) or a flexible printed circuit board (FPC) (not illustrated).

The first sensing electrodes 34a and the second sensing electrodes 34b are respectively constituted of the thin metal wires 35 (refer to FIG. 7). The wire width d (refer to FIG. 7) of the thin metal wire 35 is preferably 0.1 μm or more and 5 μm or less and more preferably 0.5 μm or more and 4 μm or less. In a case in which the wire width d of the thin metal wire 35 is in the above-described range, it is possible to relatively easily form low resistances in the first sensing, electrodes 34a and the second sensing electrodes 34b.

The thickness of the thin metal wire 35 is not particularly limited, but is preferably 0.001 mm to 0.2 mm, more preferably 30 μm or less, still more preferably 20 μm or less, particularly preferably 0.01 to 9 μm, and most preferably 0.05 to 5 μm. In the above-described range, it is possible to relatively easily obtain the first sensing electrodes 34a and the second sensing electrodes 34b which have a low resistance and excellent durability.

The wire width d of the thin metal wire 35 and the thickness of the thin metal wire 35 can be measured using, for example, an optical microscope, a laser microscope, a digital microscope, or the like.

The first sensing electrodes 34a and the second sensing electrodes 34b preferably have a mesh pattern 39 formed by combining a number of cells 37 constituted of the thin metal wire 35.

The respective cells 37 are constituted in, for example, a polygonal shape. Examples of the polygonal shape include triangular shapes, quadrilateral shapes such as a square shape, a rectangular shape, a parallelogram shape, and a rhombic shape, pentagonal shapes, hexagonal shapes, random polygonal shapes, and the like. In addition, some of the sides constituting the polygonal shape may be curved lines.

In a case in which the length Pa of one side of the cell 37 in the mesh pattern 39 is too short, there is a problem in that the opening ratio and the transmittance decrease and, accordingly, the transparency deteriorates. In contrast, in a case in which the length Pa of one side of the cell 37 is too long, there is a possibility that it becomes impossible to detect touch positions with a high resolution.

The length Pa of one side of the cell 37 in the mesh pattern 39 is not particularly limited, but is preferably 50 to 500 μm and more preferably 100 to 400 μm. In a case in which the length Pa of one side of the cell 37 is in the above-described range, furthermore, the transparency can be maintained favorably, and it is possible to visualize displayed images without discomfort in a case in which the electronic device is attached to the front surface of display devices.

From the viewpoint of the visible light transmittance, the opening ratio of the mesh pattern 39 formed of the thin metal wire 35 is preferably 80% or more, more preferably 85% or more, and most preferably 90% or more. The opening ratio refers to the ratio of transmissible portions excluding the thin metal wire 35 to the entire area.

In a case in which the first sensing electrodes 34a and the second sensing electrodes 34b are provided with a mesh structure formed in a mesh shape by intersecting the thin metal wire, the resistance can be decreased, the thin metal wire is not easily cut in the case of being shaped in a three-dimensional shape, and furthermore, even in a case in which the thin metal wire is cut, it is possible to decrease the influence on the resistance value of the detection electrodes.

In the case of the mesh structure, the mesh shape may be a regular shape in which the same shape is regularly arranged or a random shape. In the case of the regular shape, the regular shape is preferably a square shape, a rhombic shape, or a regularly hexagonal shape and particularly preferably a rhombic shape. In the case of the rhombic shape, the angle of the sharp corner is preferably 50° to 80° from the viewpoint of reducing moire with display devices. The mesh pitch is preferably 50 μm to 500 μm, and the opening ratio of the mesh is preferably 82% to 99%. The opening ratio of the mesh is defined as the ratio of areas not occupied by thin conductive wire in the mesh portion.

Meanwhile, as the mesh-shaped metal electrode, it is possible to use, for example, the net-like mesh-shaped metal electrode disclosed by JP2011-129501A and JP2013-149236A. Additionally, for example, detection electrodes that are used in electrostatic capacitance-type touch panels can be appropriately used.

The length Pa of the side of the cell 37, the angle of the mesh, and the opening ratio of the mesh can be measured using, for example, an optical microscope, a laser microscope, a digital microscope, or the like.

The surface resistance of the thin metal wire 35 constituting the first sensing electrodes 34a and the second sensing electrodes 34b is preferably in a range of 0.0001 to 100 Ω/sq. The upper limit value is more preferably 3 Ω/sq. or less. The lower limit value is more preferably 0.0001 Ω/sq. or more. Here, in the case of indium tin oxide (ITO) which is known as a transparent conductive film, the surface resistance is approximately 50 to 250 Ω/sq.

Meanwhile, the surface resistance of the thin metal wire 35 is a value measured in the following manner.

The surface resistance of the thin metal wire 35 was measured by cutting a continuous mesh portion in, for example, a width of 10 mm, attaching both ends to each other using conductive copper tape so that the mesh length reached 10 mm, and measuring the resistance at both ends using a 34405A multimeter manufactured by Agilent Technologies. This measured resistance value was used as the surface resistance.

The composition of the thin metal wire 35 is not particularly limited, and the thin metal wire is formed of, for example, gold (Au), silver (Ag), or copper (Cu). The thin metal wire 35 may be constituted of a thin metal wire including gold (Au), silver (Ag), or copper (Cu) and, furthermore, a binder, which is also considered as the thin metal wire 35.

In the first terminal wire portions 36a and the second terminal wire portions 36b in the peripheral wire portion 32, the wire width is preferably 500 μm or less, more preferably 50 μm or less, and particularly preferably 30 μm or less. In the above-described range, it is possible to relatively easily form low-resistance wires.

In addition, in the first terminal wire portions 36a, the first terminal portions 40a, the second terminal wire portions 36b, and the second terminal portions 40b in the peripheral wire portion 32 may be formed of the above-described thin metal wire 35. In this case, it is also possible to form the above-described mesh pattern 39. In this case, the wire width of the thin metal wire 35 is not particularly limited and is, for example, 1 μm or more and 30 μm or less. Similar to that in the first sensing electrodes 34a and the second sensing electrodes 34b, the wire width is preferably 1 μm or more and 5 μm or less and more preferably 1 μm or more and 4 μm or less. In the peripheral wire portion 32 as well, in a case in which the wire width is in the above-described range, it is possible to relatively easily form low-resistance electrodes. The peripheral wire portion 32 is preferably provided with the mesh pattern 39 since it is possible to enhance the uniformity in resistance reduction between the detection portion 30 and the peripheral wire portion 32 in the touch sensor portion 24.

The substrate 22 is constituted of a flexible transparent substrate as described above; however, since the first sensing electrodes 34a and the like are formed, the substrate is constituted of an electrical insulating material. Regarding the substrate 22, materials being used, the thickness, and the like will be described in detail.

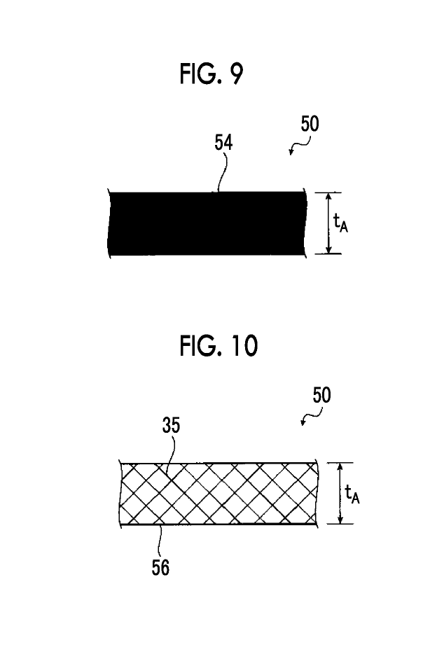

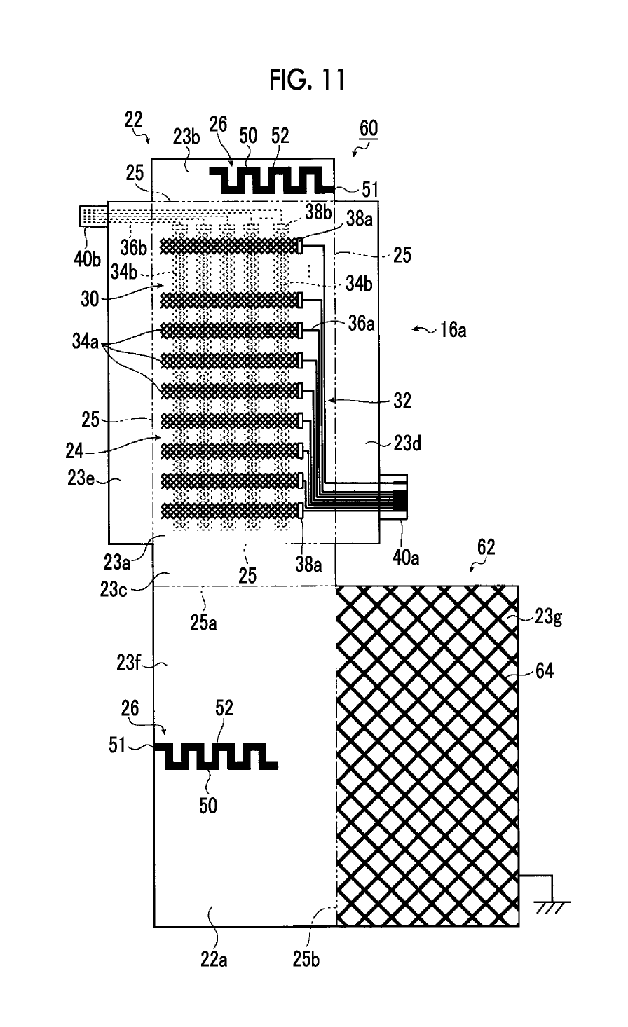

Next, the antenna 26 will be described. FIG. 8 is a schematic view illustrating an example of the antenna, FIG. 9 is a schematic view illustrating an example of an electric conductor constituting the antenna, and FIG. 10 is a schematic view illustrating another example of the electric conductor constituting the antenna.

The antenna 26 is provided in the side surface region 23b on the front surface 22a of the substrate 22 and is provided on the same surface as the first sensing electrodes 34a.

The antenna 26 has a crank-shaped structure obtained by bending a stripe-shaped electric conductor 50 having the same width. The antenna 26 is a member used for communication for sending and receiving information to and from the outside of the electronic device 10. While not illustrated, the antenna 26 is connected to the controller 18 at, for example, an end portion 51 through a coaxial cable. Therefore, communication with the outside of the electronic device 10 through the antenna 26 becomes possible.

The kind and constitution of the antenna 26 are not limited to those illustrated in FIG. 3, and it is possible to use antennas having a variety of constitutions, for example, linear antennas, batch antennas, array antennas, or arbitrary antennas including modifications thereof depending on the specification and the like of the electronic device 10. Examples thereof include a meander dipole antenna 26a illustrated in FIG. 8. The meander dipole antenna 26a has a crank-shaped structure obtained by bending a stripe-shaped electric conductor 50 having the same width and is provided in the side surface region 23b. In the meander dipole antenna 26a (hereinafter, simply referred to as the antenna 26a), a power-feeding point 52 is provided at a location about which the antenna is bilaterally symmetric.

The constitution of the electric conductor 50 varies depending on the kinds of antennas and the specifications even for the same antenna. For the electric conductor 50 used for the antenna 26 illustrated in FIG. 3 and the antenna 26a illustrated in FIG. 8, the width t_{A} is preferably 150 μm or more. This width t_{A} is the width of the electric conductor 50 constituting the patterns of the antenna 26 and the antenna 26a and is thus also referred to as the pattern width.

The electric conductor 50 may be constituted of one foil-shaped conductor 54 as illustrated in FIG. 9 or a conductor 56 constituted of the above-described thin metal wire 35 as illustrated in FIG. 10. The thin metal wire 35 is a material constituting the first sensing electrodes 34a and the second sensing electrodes 34b and will not be described in detail. In addition, the conductor 56 may have the same pattern as the first sensing electrodes 34a and the second sensing electrodes 34b or may have a different pattern.

In addition, the electric conductor 50 can also be constituted of the thin metal wire constituting the first terminal wire portions 36a and the second terminal wire portions 36b (not illustrated).

The antenna 26 illustrated in FIG. 3 and the antenna 26a illustrated in FIG. 8 are both provided in the side surface region 23b, not in the planar region 23a, in the touch sensor 16 (the number of antennas provided is one), but the place in which the antenna is provided is not limited thereto, and the antenna can be provided in any of the side surface regions 23b to 23e. In addition, it is also possible to provide a plurality of antennas in a plurality of side surface regions out of the side surface regions 23b to 23e, thereby providing a constitution including a plurality of antennas.

Since the size of the substrate 22 does not change even in a case in which the antenna 26 and the antenna 26a are provided in the plurality of side surface regions 23b to 23e, it is possible to suppress an increase in the size of the touch sensor 16.

The antenna 26 and the antenna 26a may be constituted of the same material as the touch sensor portion 24. That is, the electric conductor 50 and the thin metal wire 35 may be constituted of the same material. The definition of the same material has already been described above and thus will not be described in detail.

In addition, in a case in which the electric conductor 50 and the thin metal wire 35 are produced using the same manufacturing steps, the electric conductor and the thin metal wire can be constituted of the same material. The surface resistance of the electric conductor 50 is preferably low from the viewpoint of characteristics required for the antenna 26 and the antenna 26a. The surface resistance of the electric conductor 50 is, similar to that of the thin metal wire 35, preferably in a range of 0.0001 to 100 Ω/sq. and more preferably 0.001 to 3 Ω/sq. In the case of being constituted of the same material, the electric conductor 50 and the thin metal wire 35 are preferably constituted of copper. In this case, the copper may be pure copper or copper including a binder.

In addition, regarding the electric conductor 50 and the thin metal wire 35, it is preferable that the width t_{A} of the electric conductor 50 is 150 μm or more and the wire width d of the thin metal wire 35 is 5 μm or less.

The method for forming the touch sensor portion 24 and the antenna 16 in the touch sensor 26 is not particularly limited. For example, a wire formation method in which a plating method is used may be used. As the plating method, only electroless plating may be carried out or electrolytic plating may be carried out after electroless plating. In addition, the wire formation method in which the plating method is used may be a subtractive method, a semi-active method, or a fully additive method. In addition, the touch sensor portion and the antenna can be formed by exposing a photosensitive material having an emulsion layer containing a photosensitive silver halide salt to light and carrying, out a development treatment. In addition, the detection portion 30 and the peripheral wire portion 32 of the first sensing electrodes 34a and the second sensing electrodes 34b and the antenna 26 can be formed by forming metal foils on the substrate 22, printing a resist on the respective metal foils in a pattern shape or exposing to light and developing a resist applied to the entire surface so as to form a pattern, and etching metal in opening portions. Examples of additional formation methods include a method in which paste including the fine particles of the material constituting the above-described conductor is printed and metal plating is carried out on the paste and a method in which an ink jet method in which ink including the fine particles of the material constituting the above-described conductor is used is used.

In addition, in a case in which the first sensing electrodes 34a, the first terminal wire portions 36a, the first wire connection portions 38a, and the antenna 26 are formed on the same surface and the first sensing electrodes 34a are formed using exposure, the first sensing electrodes 34a, the first terminal wire portions 36a, the first wire connection portions 38a, and the antenna 26 can be collectively formed by using an exposure pattern as patterns for the respective portions. Therefore, it is possible to simplify the manufacturing steps and suppress the manufacturing costs. Furthermore, these can be formed of the same material. In addition, the first sensing electrodes, the first terminal wire portions, the first wire connection portions, and the antenna can be formed of the same material. In addition, in a case in which the first sensing electrodes 34a and the second sensing electrodes 34b are formed by exposing both surfaces of the substrate 22 to light at the same time, furthermore, the second sensing electrodes 34b can also be collectively formed, and thus it is possible to further increase the production efficiency and further suppress the manufacturing costs.

In the touch panel 20 of the first embodiment, in a case in which a three-dimensional shape is provided, the antenna 26 is provided in the side surface region 23b which is a side surface, and thus it is possible to further decrease the number of components and further simplify the constitution compared with a case in which antennas are separately provided. Therefore, it is possible to reduce the weight and suppress the costs. In addition, since the three-dimensional shape is provided by bending the side surface regions 23b to 23e, even in a case in which the antenna 26 is provided, the bezel can be slimmed. Furthermore, since it is possible to secure a space on a side surface of the electronic device 10 for the antenna 26 to be provided, the size can also be reduced.

Since the side surface regions 23b to 23e are bent, it is possible to put the antenna 26 and the detection portion 30 apart from each other and suppress crosstalk and noise.

Since the antenna 26 is provided in the side surface region 23b, it is possible to secure a sufficient space for the installation of the antenna 26 and increase the degree of freedom in terms of the length of the antenna 26. Therefore, it is possible to prevent a decrease in the receiving sensitivity attributed to antenna noise. In addition, even in a case in which the plurality of antennas 26 are provided in the side surface regions 23b to 23e, it is possible to suppress an increase in the number of components and simplify the constitution.

Since the first sensing electrodes 34a and the antenna 26 are provided on the front surface 22a of the substrate 22, it is possible to collectively form the first sensing electrodes and the antenna on the same front surface 22a of one substrate 22 by the same step as described above without separately forming the first sensing electrodes 34a and the antenna 26. Therefore, for the substrate as well, it is possible to simplify the manufacturing steps and suppress the manufacturing costs.

In addition, since one substrate 22 is provided with a three-dimensional shape by, for example, being bent, it is possible to secure a region for providing the antenna 26 by increasing the number of bendable regions in the substrate 22. Therefore, even without an increase in the number of components, the degree of freedom in terms of design can be enhanced, and furthermore, an increase in the size of the apparatus can also be suppressed. Furthermore, since the respective portions are formed while one substrate 22 is in a planar state, it is possible to easily increase the number and kinds of antennas. Even in a case in which the number and kinds of antennas are easily increased, the antennas can be collectively formed using the manufacturing steps of the first sensing electrodes 34a and the like as long as the antennas are disposed on the same surface as the first sensing electrodes 34a and the like, and thus it is possible to decrease the number of steps increased and suppress an increase in the manufacturing costs as well.

In the electronic device 10, the front surface 10a serves as the display surface, but it is possible to use any one surface of the six surfaces of the electronic device 10 as the display surface, and all of the six surfaces may serve as display surfaces. For example, in a case in which images are displayed on the side surfaces 10c to 10f of the electronic device 10 using the display panel 14, optically transparent regions are provided on the side surfaces of the chassis 12 which correspond to the side surfaces 10c to 10f of the electronic device 10. Furthermore, it is also possible to add the display panel 14 on the rear surface 10b side and provide an optically transparent region on the rear surface of the chassis 12.

Next, a touch panel of a second embodiment of the present invention will be described.

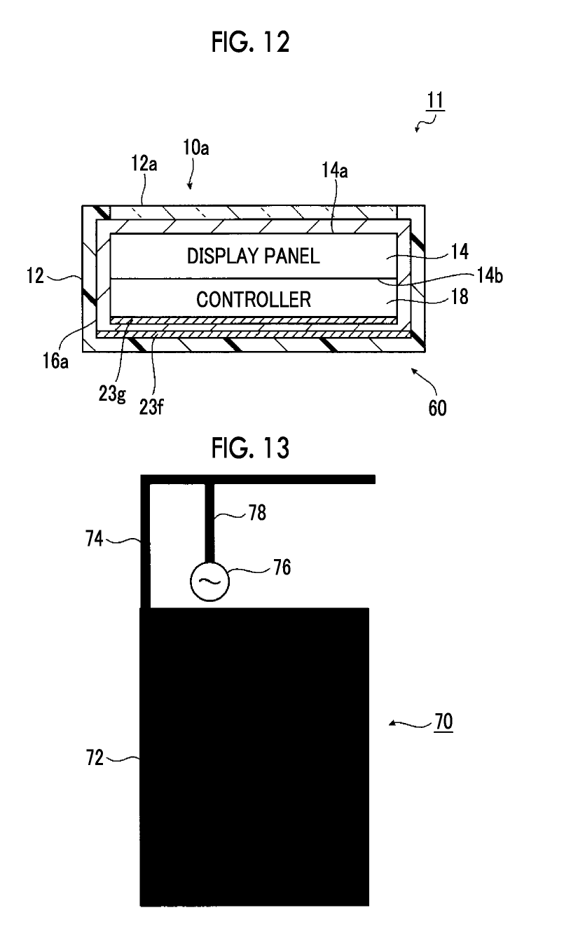

FIG. 11 is a schematic plan view illustrating the touch panel of the second embodiment of the present invention. FIG. 12 is a schematic cross-sectional view illustrating an electronic device including the touch panel of the second embodiment of the present invention. FIG. 13 is a schematic view illustrating an example of an antenna.

Meanwhile, in a touch panel 60, a touch sensor 16a, and an electronic device 11 in the present embodiment illustrated in FIGS. 11 to 13, the same components as those in the touch panel 20, the touch sensor 16, and the electronic device 10 in the first embodiment will be given the same reference sign and will not be described in detail.

Compared with the touch panel 20 (refer to FIG. 3) and the touch sensor 16 (refer to FIG. 3) of the first embodiment, the touch panel 60 and the touch sensor 16a in the present embodiment, which are illustrated in FIG. 11, have differences in terms of the constitution of the substrate 22, the number of the antennas 26, and furthermore, the presence of a shield portion. Other constitutions are the same as the constitutions of the touch panel 20 of the first embodiment, the touch sensor 16, and the electronic device 10 in the first embodiment and thus will not be described in detail.

In one substrate 22 in the touch panel 60, a region 23f is provided so as to be continuous to the side surface region 23c, and a region 23g is provided so as to be continuous to the region 23f. The region 23f and the region 23g are as large as the planar region 23a.

In the region 23f, the antenna 26 is provided on the front surface 22a of the substrate 22. In the region 23g, a shield portion 62 is provided on the front surface 22a of the substrate 22.

The region 23f is bent toward the planar region 23a at a boundary 25a between the region 23f and the side surface region 23c so as to face the planar region 23a. In addition, the region 23g is bent at a boundary 25b between the region 23f and the region 23g so as to overlay the region 23f and is disposed between the region 23f and the planar region 23a. Therefore, as in the electronic device 11 illustrated in FIG. 12, the shield portion 62 is disposed between the antenna 26 in the region 23f and the controller 18.

The shield portion 62 is a member that shields electromagnetic noise travelling toward at least one of the touch sensor portion 24 or the antenna 26, and the shield portion 62 is grounded. Due to the shield portion 62, it is possible to suppress the adverse influence on the touch sensor portion 24 or the antenna 26 of electrical signals which are generated from the operation of the display panel 14 or the controller 18 and leak into the touch sensor portion or the antenna.

Regarding the shield portion 62, the constitution of the shield portion 62 and the disposition location of the shield portion 62 are not particularly limited as long as the above-described electromagnetic noise-shielding effect can be exhibited and the adverse influence caused by the leakage of electrical signals can be suppressed.

For example, the shield portion 62 can be constituted in a mesh pattern using an electric conductive wire 64 as illustrated in FIG. 11. The size of the openings in the mesh pattern is appropriately determined depending on the frequencies of electromagnetic waves to be shielded. In addition, the shield portion 62 can also be constituted of an electric conductive film that is formed on the entire region 23g. The electric conductive film that is formed on the entire region 23g is a surface-like film and is a film that is referred to as a solid film.

The shield portion 62 is formed on, for example, the front surface 22a of the substrate 22. The shield portion 62 may also be formed on the rear surface 22b of the substrate 22.

The shield portion 62 can also be constituted of the same material as the first sensing electrodes 34a, the second sensing electrodes 34b, and the antenna 26. The definition of the same material has already been described above and thus will not be described in detail.

Meanwhile, in a case in which the first sensing electrodes 34a, the second sensing electrodes 34b, the antenna 26, and the shield portion 62 are formed by the same step, these components can be constituted of the same material.

In the touch panel 60, since the region 23f is as large as the planar region 23a, for example, an antenna 70 illustrated in FIG. 13 can be formed in the region 23f. The antenna 70 illustrated in FIG. 13 is an antenna that is referred to as an inverted-F antenna, has a main body portion 72 and an antenna element 74, and has a power-feeding point 76 provided in the antenna element 74 through a conductor 78.

Similar to the antenna 26, the antenna 70 may also be constituted of one foil-shaped conductor or a conductor constituted of the same thin metal wire 35 as that for the above-described first sensing electrodes 34a and the second sensing electrodes 34b. Furthermore, it is also possible to use a conductor constituted of the same thin metal wire as the thin metal wire (not illustrated) constituting the first terminal wire portions 36a and the second terminal wire portions 36b. The antenna 70 and the first terminal wire portions 36a may be constituted of the same material.

The touch panel 60 and the touch sensor 16a in the present embodiment are capable of obtaining the same effect as that of the touch panel 20 and the touch sensor 16 in the first embodiment. Additionally, since the shield portion 62 is provided, it is possible to suppress interferences by electromagnetic noise and further suppress, for example, noise and crosstalk from the driving signals of the touch panel 20 and the display panel 14 such as liquid crystal display devices.

Since the touch panel 60 and the touch sensor 16a in the present embodiment are also provided with a three-dimensional shape by bending one substrate 22, it is possible to secure a region for providing the antenna 26 and a region for providing the shield portion 62 by increasing the number of bendable regions in the substrate 22. As described above, even without an increase in the number of components, the degree of freedom in terms of design can be enhanced, and furthermore, an increase in the size of the apparatus can also be suppressed.

Furthermore, since the respective portions are formed while one substrate 22 is in a planar state, it is possible to easily increase the number and kinds of antennas. Even in a case in which the number and kinds of antennas are easily increased, the antennas can be collectively formed using the manufacturing steps of the first sensing electrodes 34a and the like as long as the antennas are disposed on the same surface as the first sensing electrodes 34a and the like, and thus it is possible to decrease the number of steps increased and suppress an increase in the manufacturing costs as well.

Next, a touch panel of a third embodiment of the present invention will be described.

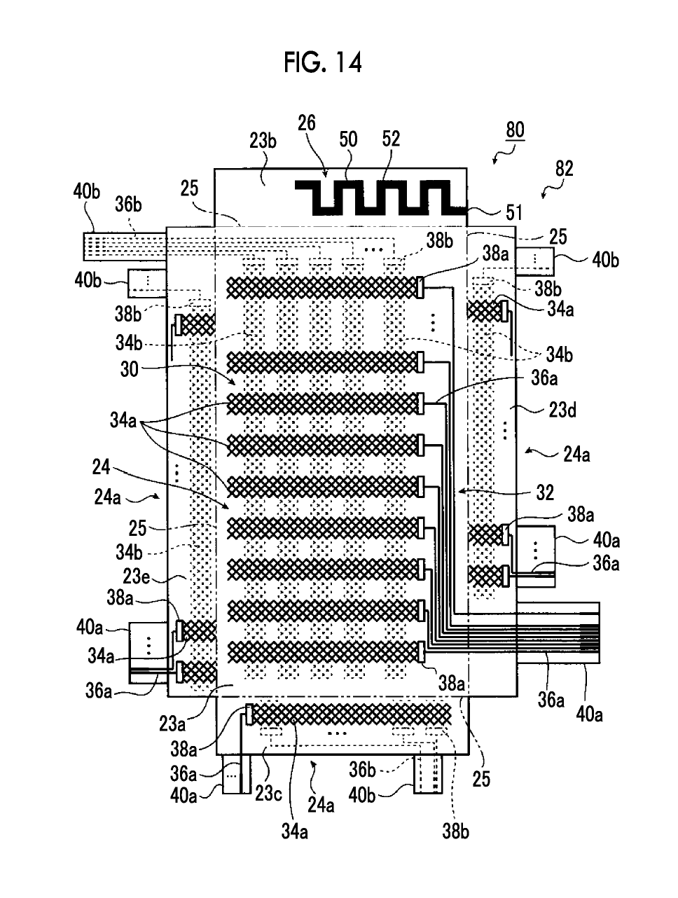

FIG. 14 is a schematic plan view illustrating the touch panel of the third embodiment of the present invention.

Meanwhile, in a touch panel 80 and a touch sensor 82 in the present embodiment illustrated in FIG. 14, the same components as those in the touch panel 20, the touch sensor 16, and the electronic device 10 in the first embodiment will be given the same reference sign and will not be described in detail.

Compared with the touch panel 20 (refer to FIG. 3) of the first embodiment and the touch sensor 16 (refer to FIG. 3), the touch panel 80 and the touch sensor 82 in the present embodiment, which are illustrated in FIG. 14, have a difference in terms of the independent provision of touch sensor portions 24a in the side surface regions 23c, 23d, and 23e of the substrate 22, and other constitutions are the same as the constitutions of the touch panel 20, the touch sensor 16, and the electronic device 10 in the first embodiment and thus will not be described in detail.

The touch sensor portions 24a provided in the side surface regions 23c, 23d, and 23e have the same constitution as the touch sensor portion 24 in the touch panel 20 of the first embodiment and thus will not be described in detail. Since the touch sensor portions 24a are respectively independently provided in the side surface regions 23c, 23d, and 23e, in a case in which the touch panel is used to produce an electronic device, it becomes possible to independently detect touching on the respective side surfaces of the electronic device.

In the touch panel 80 of the present embodiment as well, the same effect as in the touch panel 20 of the first embodiment can be obtained.

Next, a touch panel of a fourth embodiment of the present invention will be described.

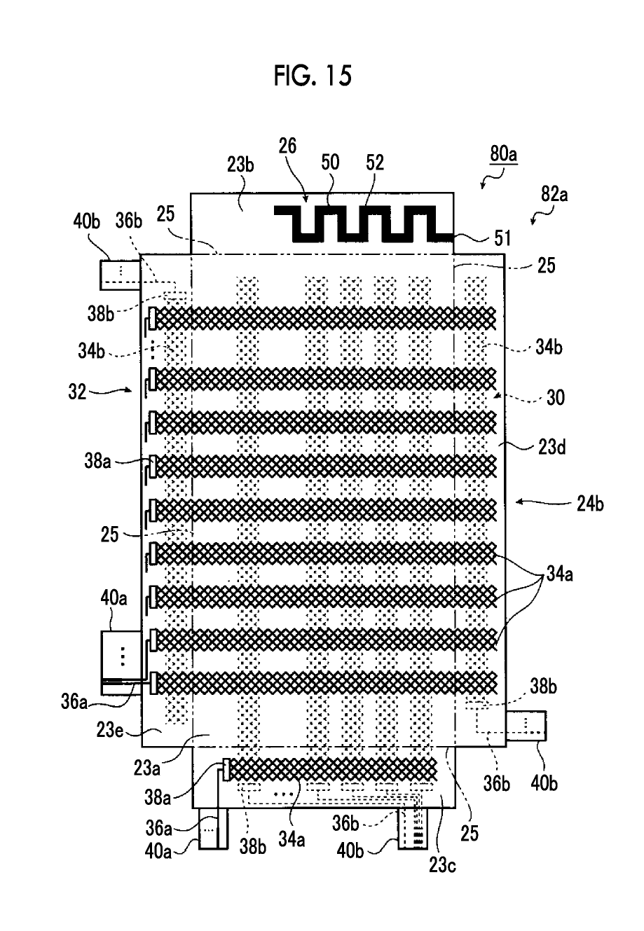

FIG. 15 is a schematic plan view illustrating the touch panel of the fourth embodiment of the present invention.

Meanwhile, in a touch panel 80a and a touch sensor 82a in the present embodiment illustrated in FIG. 15, the same components as those in the touch panel 20, the touch sensor 16, and the electronic device 10 in the first embodiment will be given the same reference sign and will not be described in detail.

Compared with the touch panel 20 (refer to FIG. 3) and the touch sensor 16 (refer to FIG. 3), the touch panel 80a and the touch sensor 82a in the present embodiment, which are illustrated in FIG. 15, have differences in terms of the capability of detecting touching in the side surface regions 23c, 23d, and 23e as well as in the planar region 23a and the constitution of a touch sensor portion 24b, and other constitutions are the same as the constitutions of the touch panel 20 of the first embodiment, the touch sensor 16, and the electronic device 10 in the first embodiment and thus will not be described in detail.

Compared with the touch sensor portion 24 in the touch panel 20 of the first embodiment, in the touch sensor portion 24b, the first sensing electrodes 34a are disposed in the first direction at intervals in the side surface region 23d, the planar region 23a, and the side surface region 23e. The first terminal wire portions 36a and the first wire connection portions 38a are provided in the side surface region 23c and the side surface region 23e.

The second sensing electrodes 34b are disposed in the second direction at intervals in the side surface region 23d, the planar region 23a, the side surface region 23c, and the side surface region 23e. In the touch sensor portion 24b as well, the first terminal portions 40a and the second terminal portions 40b are electrically connected to the controller (refer to FIG. 2) using, for example, a connector 18 (not illustrated) or a flexible printed circuit board (FPC) (not illustrated).

In the touch sensor portion 24b, the plurality of first sensing electrodes 34a are set to be common in the planar region 23a and the side surface region 23c, and the plurality of second sensing electrodes 34b are set to be common in the planar region 23a, the side surface region 23d, and the side surface region 23e. In the touch panel 80a and the touch sensor 82a, it is possible to form sensor regions in which touching can be detected anywhere except for the side surface region 23b in which the antenna 26 is provided. Therefore, in a case in which the touch panel is used to produce an electronic device (not illustrated), it is possible to detect touching on side surfaces of the electronic device in which the antenna 26 is not disposed.

Meanwhile, in the touch panel 80a and the touch sensor 82a in the present embodiment as well, the same effect as in the touch panel 20 and the touch sensor 16 in the first embodiment can be obtained.

Next, a touch panel of a fifth embodiment of the present invention will be described.

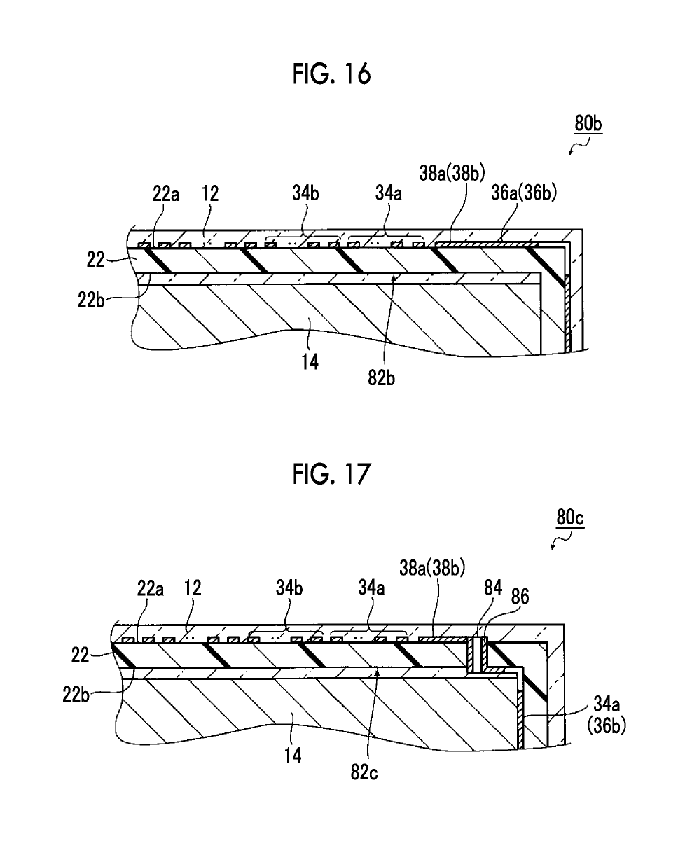

FIG. 16 is a cross-sectional view of a main portion illustrating the touch panel of the fifth embodiment of the present invention, and FIG. 17 is a cross-sectional view of a main portion illustrating a modification example of the touch panel of the fifth embodiment of the present invention illustrated in FIG. 16. FIG. 16 and FIG. 17 illustrate a part of the display panel 14.

Meanwhile, in a touch panel 80b and a touch sensor 82b in the present embodiment illustrated in FIG. 16, the same components as those in the touch panel 20, the touch sensor 16, and the electronic device 10 in the first embodiment will be given the same reference sign and will not be described in detail.

In addition, in a touch panel 80c and a touch sensor 82c in the modification example of the present embodiment illustrated in FIG. 17, the same components as those in the touch panel 20, the touch sensor 16, and the electronic device 10 in the first embodiment will be given the same reference sign and will not be described in detail.

Compared with the touch panel 20 (refer to FIG. 3) of the first embodiment and the touch sensor 16 (refer to FIG. 3), the touch panel 80b of the present embodiment has a difference in terms of the first sensing electrodes 34a and the second sensing electrodes 34b being formed on any one surface of the front surface 22a or the rear surface 22b of the substrate 22, and other constitutions are the same as the constitutions of the touch panel 20, the touch sensor 16, and the electronic device 10 in the first embodiment and thus will not be described in detail.

In the touch panel 80b illustrated in FIG. 16, the first sensing electrodes 34a and the second sensing electrodes 34b are formed on the front surface 22a of the substrate 22.

In addition, the touch panel 80c illustrated in FIG. 17 has a constitution in which wires formed toward the front surface 22a of the substrate 22 in the first terminal wire portions 36a and the second terminal wire portions 36b are extracted to the rear surface 22b of the substrate 22 through an electric conductive layer 86 having the first terminal wire portions 36a and the second terminal wire portions 36b forming in a through-hole 84. Other constitutions are the same as the constitutions of the touch panel 80b of the present embodiment and thus will not be described in detail.

In the touch panel 80c illustrated in FIG. 17, the through-hole 84 is formed in the substrate 22, and the electric conductive layer 86 is formed in the through-hole 84. The through-hole 84 and the electric conductive layer 86 can be formed using, for example, a method for forming plated through-holes that are used for electric connection among individual layers in multi-layer printed circuit boards.

Meanwhile, in the touch panel 80b and the touch sensor 82b in the present embodiment and the touch panel 80c and the touch sensor 82c in the modification example as well, the same effect as in the touch panel 20 and the touch sensor 16 in the first embodiment can be obtained.

Next, a touch panel of a sixth embodiment of the present invention will be described.

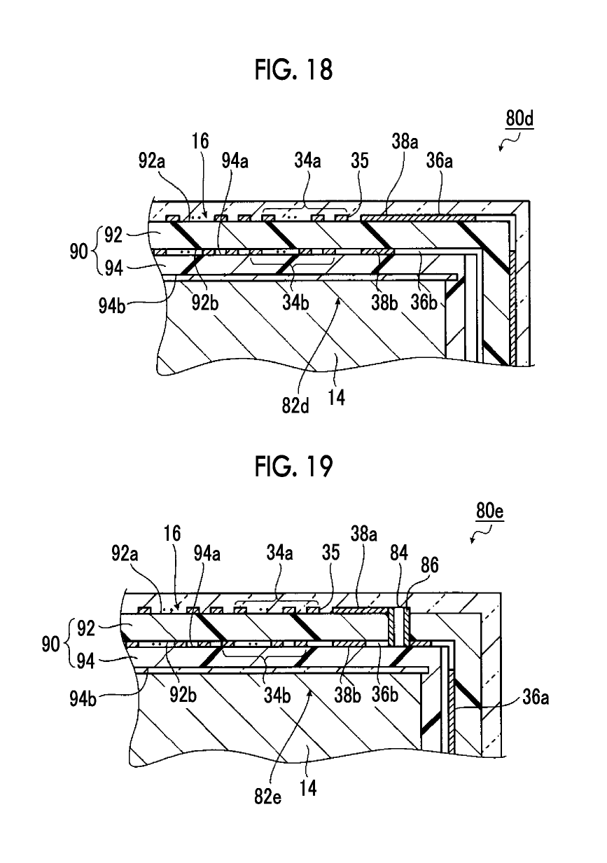

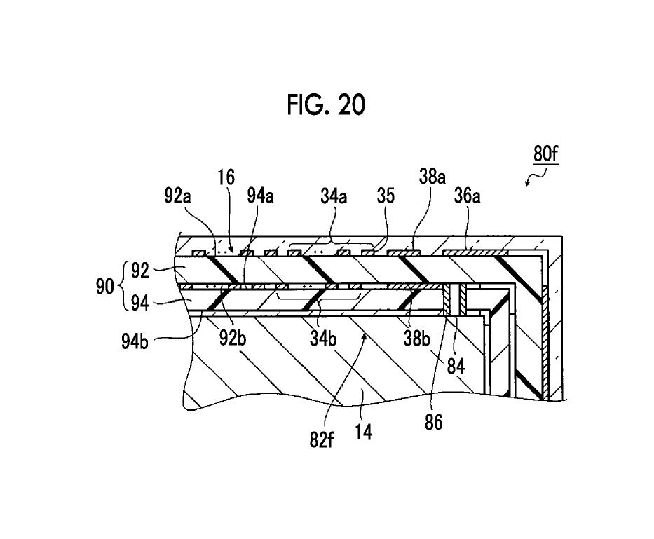

FIG. 18 is a cross-sectional view of a main portion illustrating the touch panel of the sixth embodiment of the present invention, FIG. 19 is a cross-sectional view of a main portion illustrating a first modification example of the touch panel of the sixth embodiment of the present invention, and FIG. 20 is a cross-sectional view of a main portion illustrating a second modification example of the touch panel of the sixth embodiment of the present invention. FIGS. 18 to 20 illustrate a part of the display panel 14.

Meanwhile, in a touch panel 80d and a touch sensor 82d in the present embodiment illustrated in FIG. 18, the same components as those in the touch panel 20, the touch sensor 16, and the electronic device 10 in the first embodiment will be given the same reference sign and will not be described in detail.

In addition, in a touch panel 80e and a touch sensor 82e in the first modification example of the present embodiment illustrated in FIG. 19 and a touch panel 80f and a touch sensor 82f in the second modification example of the present embodiment illustrated in FIG. 20, the same components as those in the touch panel 20, the touch sensor 16, and the electronic device 10 in the first embodiment will be given the same reference sign and will not be described in detail.

Compared with the touch panel 20 (refer to FIG. 3) of the first embodiment and the touch sensor 16 (refer to FIG. 3), the touch panel 80d of the present embodiment has a difference in terms of the constitution of a substrate 90 and the places in which the first sensing electrodes 34a and the second sensing electrodes 34b are provided, and other constitutions are the same as the constitutions of the touch panel 20, the touch sensor 16, and the electronic device 10 in the first embodiment and thus will not be described in detail.

In the touch panel 80d of the present embodiment, the substrate 90 has a bilayer structure of a first support 92 and a second support 94. In the substrate 90, the first support 92 is disposed and laminated on a front surface 94a of the second support 94. As the first support 92 and the second support 94, the same transparent substrate as the substrate 22 in the touch panel 20 of the first embodiment can be used, and thus the constitution and the like thereof will not be described in detail.

The first support 92 and the second support 94 are adhered using, for example, an optically transparent pressure-sensitive adhesive called optically clear adhesives (OCA) or an optically transparent resin such as an ultraviolet-curable resin called optically clear resin (OCR). In addition, there may be a hollow portion, that is, an air gap between the first support 92 and the second support 94.

In the touch panel 80d, the first sensing electrodes 34a, the first terminal wire portions 36a, and the first wire connection portions 38a are formed on a front surface 92a of the first support 92. The second sensing electrodes 34b, the second terminal wire portions 36b, and the second wire connection portions 38b are formed on the front surface 94a of the second support 94.

The first support 92 having the first sensing electrodes 34a, the first terminal wire portions 36a, and the first wire connection portions 38a formed on the front surface 92a and the second support 94 having the second sensing electrodes 34b, the second terminal wire portions 36b, and the second wire connection portions 38b formed on the front surface 94a are prepared. In addition, the above-described optically transparent pressure-sensitive agent is applied onto the front surface 94a of the second support 94, and the first support 92 is disposed and laminated on the front surface 94a of the second support 94, whereby the touch panel 80d can be obtained. Meanwhile, the touch panel 80d can also be obtained by laminating the first support 92 on the front surface 94a of the second support 94 using an optically transparent resin such as an ultraviolet-curable resin instead of the optically transparent pressure-sensitive adhesive and irradiating the resin with ultraviolet rays. Meanwhile, the ultraviolet rays refer to light rays having wavelengths of 100 to 400 nm.

As the first support 92 and the second support 94 in the substrate 90, the same substrate as the substrate 22 in the touch panel 20 of the first embodiment is used, but the supports are not limited thereto. The supports can also be constituted of an insulating material as long as the insulating material is as flexible, transparent, and electrically insulating as the substrate 22.

In addition, the touch panel 80e illustrated in FIG. 19 has a constitution in which the first terminal wire portions 36a on the front surface 92a of the first support 92 are extracted to the rear surface 92b of the first support 92 through the electric conductive layer 86 formed in the through-hole 84. Other constitutions are the same as the constitutions of the touch panel 80d of the present embodiment and thus will not be described in detail.

Furthermore, the touch panel 80f illustrated in FIG. 20 has a constitution in which the second terminal wire portions 36b on the front surface 94a of the second support 94 are extracted to the rear surface 94b of the second support 94 through the electric conductive layer 86 formed in the through-hole 84. Other constitutions are the same as the constitutions of the touch panel 80d of the present embodiment and thus will not be described in detail.

In the touch panel 80e illustrated in FIG. 19 and the touch panel 80f illustrated in FIG. 20, the through-hole 84 is formed in the substrate 22, and the electric conductive layer 86 is formed in the through-hole 84. The through-hole 84 and the electric conductive layer 86 can be formed using, for example, a method for forming plated through-holes that are used for electric connection among individual layers in multi-layer printed circuit boards.

Meanwhile, in the touch panel 80d and the touch sensor 82d in the present embodiment, the touch panel 80e and the touch sensor 82e in the first modification example, and the touch panel 80f and the touch sensor 82f in the second modification example as well, the same effect as in the touch panel 20 and the touch sensor 16a in the first, embodiment can be obtained.

Hereinafter, a method for manufacturing the touch sensor 16 will be described.

As described above, the touch sensor has been described using a variety of examples, but the manufacturing method will be described typically using the touch sensor 16 illustrated in FIG. 3. As described above, the antenna 26 is formed on the same surface as the first sensing electrodes 34a in the touch sensor 16. In a case in which the first sensing electrodes 34a are formed in the planar region 23a on the front surface 22a of the substrate 22, the antenna 26 can also be formed in the side surface region 23b at the same time using the same step and the same material, for example, copper. Therefore, in the following description, the method for manufacturing the touch sensor 16 will be described, but the manufacturing method can also be applied to a method for manufacturing the antenna 26.

As the method for manufacturing the touch sensor 16, the first sensing electrodes 34a and the second sensing electrodes 34b may be formed by, for example, forming a photosensitive plated layer on the substrate 22 using a plated material, then, exposing to light and developing the photosensitive plated layer, and then carrying out a plating treatment so as to form metal portions and light-transmitting portions in exposed portions and non-exposed portions respectively. Furthermore, an electrically conductive metal may be carried in the metal portions by carrying out at least one of physical development or a plating treatment on the metal portions.

Examples of a more preferred aspect of the method in which the plated material is used include the following two aspects. Meanwhile, the more specific contents described below are disclosed by JP2003-213437A, JP2006-64923A, JP2006-58797A, JP2006-135271A, and the like.

(a) An aspect in which a plated layer including a functional group that interacts with a plating catalyst or a precursor thereof is applied onto the substrate 22, then, is exposed and developed, and is then plated, thereby forming metal portions on the plated material.

(b) An aspect in which a foundation layer including a polymer and a metal oxide and a plated layer including a functional group that interacts with a plating catalyst or a precursor thereof are laminated on the substrate 22 in this order, then, is exposed and developed, and is then plated, thereby forming metal portions on the plated material.

Alternatively, the first sensing electrodes 34a and the second sensing electrodes 34b may be formed by exposing a photosensitive material having an emulsion layer containing a photosensitive silver halide salt to light on the substrate 22 and carrying out a development treatment so as to form metal portions and light-transmitting portions in exposed portions and non-exposed portion respectively. Furthermore, an electrically conductive metal may be carried in the metal portions by carrying out at least one of physical development or a plating treatment on the metal portions.

As another method, the first sensing electrodes 34a and the second sensing electrodes 34b may be formed by exposing to light and developing a photoresist film on a metal foil formed on the substrate 22 so as to form a resist pattern and etching portions of the metal foil which are exposed through the resist pattern.

Alternatively, the mesh pattern 36 may be formed by printing paste including fine metal particles on the substrate 22 and carrying out metal plating on the paste.

Alternatively, the mesh pattern 36 may be printed and formed on the substrate 22 using a screen printing plate or a gravure printing plate.

Alternatively, the first sensing electrodes 34a and the second sensing electrodes 34b may be formed on the substrate 22 by means of ink jetting.

Alternatively, a resin layer is formed on a film, an incised pattern is formed in the resin layer by pressing an embossed pattern-formed mold onto the resin layer, and then an electrode material is applied onto the entire surface of the resin layer including the incised pattern. After that, a mesh pattern may be formed of the electrode material loaded in the incised pattern in the resin layer by removing a conductive material on the front surface of the resin layer.

Next, a method in which a plating method that is a particularly preferred aspect s used for the touch sensor 16 will be mainly described.

The method for manufacturing the touch sensor 16 has a step of forming a pattern-shaped plated layer on a substrate (Step 1) and a step of forming a pattern-shaped metal layer on the patter-shaped plated layer (Step 2).

Hereinafter, members and materials that are used in the respective steps and the order of the steps will be described in detail.

[Step 1: Pattern-Shaped Plated Layer-Forming Step]

Step 1 is a step of forming a pattern-shaped plated layer on a substrate by imparting energy to a composition for forming a plated layer which contains a compound having a functional group that interacts with metal ions (hereinafter, also referred to as “interactive group”) and a polymerizable group in a pattern shape. More specifically, in the step, first, a coating of the composition for forming a plated layer is formed on the substrate 22, and energy is imparted to the obtained coating in a pattern shape so as to accelerate a reaction of the polymerizable group and cure the coating, and then regions that have not been imparted with the energy are removed, thereby obtaining a pattern-shaped plated layer.

The pattern-shaped plated layer obtained in the above-described step adsorbs (attaches) metal ions thereto in Step 2 described below according to the function of the interactive group. That is, the pattern-shaped plated layer functions as a favorable metal ion-receiving layer. In addition, the polymerizable group is used to bond compounds together by means of a curing treatment in which energy is imparted, whereby the pattern-shaped plated layer having excellent hardness can be obtained.

Hereinafter, first, members and materials that are used in the present step will be described in detail, and then the order of the step will be described in detail.

(Substrate)

The substrate 22 has two main surfaces and is constituted of a flexible transparent substrate as described above, but is constituted of an electrical insulating material since the sensing electrodes and the like are formed on the substrate. For example, flexible substrates such as plastic films or plastic plates can be used. The plastic films and the plastic plates can be constituted of, for example, polyesters such as polyethylene terephthalate (PET) and polyethylene naphthalate (PEN), polyolefins such as polyethylene (PE), polypropylene (PP), polystyrene, ethylene vinyl acetate (EVA), cycloolefin polymers (COP), and cycloolefin copolymers (COC), vinyl-based resins, additionally, polycarbonate (PC), polyamide, polyimide, acrylic resins, triacetyl cellulose (TAC), and the like. From the viewpoint of a light-transmitting property, a thermally shrinkable property, workability, and the like, the plastic films and the plastic plates are preferably constituted of polyolefins such as polyethylene terephthalate (PET), cycloolefin polymers (COP), and cycloolefin copolymers (COC).

As the substrate 22, it is also possible to use a treatment agent support on which at least one treatment of an atmospheric-pressure plasma treatment, a corona discharge treatment, or an ultraviolet irradiation treatment is carried out. In a case in which the above-described treatment is carried out, hydrophilic groups such as OH groups are introduced into the surface of the treatment agent support, and the adhesiveness to the first sensing electrodes 34a and the second sensing electrodes 34b further improves. Among the above-described treatments, the atmospheric-pressure plasma treatment is preferred since the adhesiveness to the first sensing electrodes 34a and the second sensing electrodes 34b further improves.

The thickness of the substrate 22 is preferably 5 to 350 μm and more preferably 30 to 150 μm. In a case in which the thickness is in a range of 5 to 350 μm, as described above, the substrate obtains visible light transmittance, that is, becomes transparent, and it is also easy to handle the substrate.

(Composition for Forming Plated Layer)

To the composition for forming a plated layer, a compound having a functional group that interacts with metal ions and a polymerizable group is added.

The functional group that interacts with metal ions refers to a functional group capable of interacting with metal ions that are imparted to the patterns-shaped plated layer in the step described below, and, for example, functional group capable of forming an electrostatic interaction with metal ions or nitrogen-containing functional groups, sulfur-containing functional groups, oxygen-containing functional groups, and the like which are capable of forming a coordination with metal ions can be used.

More specific examples of the interactive group include nitrogen-containing functional groups such as an amino group, an amide group, an imide group, an urea group, a tertiary amino group, an ammonium group, an amidino group, a triazine ring, a triazole ring, a benzotriazole group, an imidazole group, a benzimidazole group, a quinolone group, a pyridine group, a pyrimidine group, a pyrazine group, a nazoline group, a quinoxaline group, a purine group, a triazine group, a piperidine group, a piperazine group, a pyrrolidine group, a pyrazole group, an aniline group, groups having an alkyl amine structure, groups having an isocyanuric structure, a nitro group, a nitroso group, an azo group, a diazo group, an azide group, a cyano group, and a cyanate group (R—O—CN); oxygen-containing functional groups such as an ether group, a hydroxyl group, a phenolic hydroxyl group, a carboxyl group, a carbonate group, a carbonyl group, an ester group, groups having an N-oxide structure, groups having an S-oxide structure, and groups having an N-hydroxy structure; sulfur-containing functional groups such as a thiophene group, a thiol group, a thiourea group, a thiocyanuric acid group, a benzothiazole group, a mercapto-triazine group, a thioether group, a thioxy group, a sulfoxide group, a sulfone group, a sulfide group, groups having a sulfoximine structure, groups having a sulfoxinium salt structure, a sulfonic acid group, and groups having a sulfonic acid ester structure; phosphorus-containing functional groups such as a phosphate group, a phosphoroamide group, a phosphine group, and groups having a phosphoric acid ester structure; groups having a halogen atom such as chlorine or bromine, and the like, and it is also possible to use salts of functional groups capable of having a salt structure.

Among these, ionic polar groups such as a carboxyl group, a sulfonic acid group, a phosphoric acid group, and a boronic acid group, an ether group, and a cyano group are particularly preferred, and a carboxyl group or a cyano group is more preferred due to their high polarity and high adsorption capability to metal ions.

In the compound, two or more kinds of interactive groups may be included. In addition, the number of the interactive groups in the compound is not particularly limited and may be one or two.

The polymerizable group is a functional group capable of forming a chemical bond in the case of being imparted with energy, and examples thereof include radical polymerizable groups, cationic polymerizable groups, and the like. Among these, radical polymerizable groups are preferred due to their superior reactivity. Examples of the radical polymerizable groups include unsaturated carboxylic acid ester groups such as acrylic acid ester groups (acryloyloxy groups), methacrylic acid ester groups (methacryloyloxy groups), itaconic acid ester groups, crotonic acid ester groups, isocrotonic acid ester groups, and maleic acid ester groups, a styryl group, a vinyl group, an acrylamide group, a methacrylamide group, and the like. Among these, a methacryloyloxy group, an acryloyloxy group, a vinyhl group, a styryl group, an acrylamide group, and a methacrylamide group are preferred, and a methacryloyloxy group, an acryloyloxy group, and a styryl group are particularly preferred.

In the compound, two or more kinds of polymerizable groups may be included. In addition, the number of the polymerizable groups in the compound is not particularly limited and may be one or two or more.

The compound may be a low-molecular-weight compound or a high-molecular-weight compound. The low-molecular-weight compound refers to a compound having a molecular weight of less than 1,000, and the high-molecular-weight compound refers to a compound having a molecular weight of 1,000 or more.

Meanwhile, the low-molecular-weight compound having the above-described polymerizable group corresponds to a so-called monomer. In addition, the high-molecular-weight compound may be a polymer having a predetermined repeating unit.

In addition, only one kind of compound may be used, or two or more kinds of compounds may be jointly used.

In a case in which the compound is a polymer, the weight-average molecular weight of the polymer is not particularly limited, but is preferably 1,000 or more and 700,000 or less and more preferably 2,000 or more and 200,000 or less from the viewpoint of the superior handleability such as solubility. Particularly, from the viewpoint of the polymerization sensitivity, the weight-average molecular weight is preferably 20,000 or more.

A method for synthesizing the polymer having the polymerizable group and the interactive group is not particularly limited, and a well-known synthesis method (refer to Paragraphs [0097] to [0125] of JP2009-280905A) is used.

(Preferred Aspect 1 of Polymer)

A first preferred aspect of the polymer includes copolymers having a repeating unit having a polymerizable group represented by Formula (a) (hereinafter, also appropriately referred to as the polymerizable group unit) and a repeating unit having an interactive group represented by Formula (b) (hereinafter, also appropriately referred to as the interactive group unit).

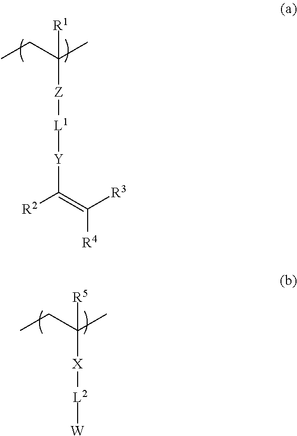

In Formulae (a) and (b), R¹ to R⁵ each independently represent a hydrogen atom or a substituted or unsubstituted alkyl group (for example, a methyl group, an ethyl group, a propyl group, a butyl group, or the like). Meanwhile, the kind of the substituent is not particularly limited, and examples thereof include a methoxy group, a chlorine atom, a bromine atom, a fluorine atom, and the like.

Meanwhile, R¹ is preferably a hydrogen atom, a methyl group, or a methyl group substituted with a bromine atom. R² is preferably a hydrogen atom, a methyl group, or a methyl group substituted with a bromine atom. R³ is preferably a hydrogen atom. R⁴ is preferably a hydrogen atom. R⁵ is preferably a hydrogen atom, a methyl group, or a methyl group substituted with a bromine atom.

In Formula (a) and Formula (b), X, Y, and Z each independently represent a single bond or a substituted or unsubstituted divalent organic group. Examples of the divalent organic group include substituted or unsubstituted divalent aliphatic hydrocarbon groups (preferably having 1 to 8 carbon atoms; for example, alkylene groups such as a methylene group, an ethylene group, and a propylene group), substituted or unsubstituted divalent aromatic hydrocarbon groups (preferably having 6 to 12 carbon atoms; for example, a phenylene group), —O—, —S—, —SO₂—, —N(R)— (R: alkyl group), —CO—, —NH—, —COO—, —CONH—, groups obtained by combining the above-described groups (for example, an alkyleneoxy group, an alkyleneoxy carbonyl group, an alkylene carbonyloxy group, and the like), and the like.

X, Y, and Z are preferably single bonds, ester groups (—COO—), amide groups (—CONH—), ether groups (—O—), or substituted or unsubstituted divalent aromatic hydrocarbon groups and more preferably single bonds, ester groups (—COO—), and amide groups (—CONH—) since it is easy to synthesize the polymer and the adhesiveness of the pattern-shaped metal layer is superior.

In Formula (a) and Formula (b), L¹ and L² each independently represent a single bond or a substituted or unsubstituted divalent organic group. The definition of the divalent organic group is the same as the definition of the divalent organic group described regarding X, Y, and Z.

L¹ is preferably an aliphatic hydrocarbon group or a divalent organic group having an urethane bond or an urea bond (for example, an aliphatic hydrocarbon group) since it is easy to synthesize the polymer and the adhesiveness of the pattern-shaped metal layer is superior, and, among these, groups having a total of 1 to 9 carbon atoms are preferred. Meanwhile, here, the total number of carbon atoms in L¹ refers to the number of all carbon atoms in the substituted or unsubstituted divalent organic group represented by L¹.

In addition, L² is preferably a single bond, a divalent aliphatic hydrocarbon group, a divalent aromatic hydrocarbon group, or a group obtained by combining the above-described groups since the adhesiveness of the pattern-shaped metal layer is superior. Among these, L² is preferably a single bond or a group having a total of 1 to 15 carbon atoms and particularly preferably an unsubstituted group. Meanwhile, here, the total number of carbon atoms in L² refers to the number of all carbon atoms in the substituted or unsubstituted divalent organic group represented by L².

In Formula (b), W represents the interactive group. The definition of the interactive group is as described above.

The content of the polymerizable group unit is preferably 5 to 50 mol % and more preferably 5 to 40 mol % of the total repeating units in the polymer from the viewpoint of reactivity (the curing property and the polymerization property) and the suppression of gelation in the case of synthesis.

In addition, the content of the interactive group unit is preferably 5 to 95 mol % and more preferably 10 to 95 mol % of the total repeating units in the polymer from the viewpoint of the adsorption property to metal ions.

(Preferred Aspect 2 of Polymer)

A second preferred aspect of the polymer includes copolymers having a repeating unit represented by Formula (A), Formula (B), and Formula (C).

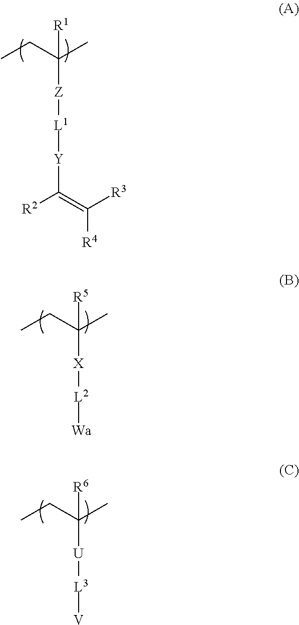

The repeating unit represented by Formula (A) is the same as the repeating unit represented by Formula (a), and the descriptions of the respective groups are also identical.

R⁵, X, and L² in the repeating unit represented by Formula (B) are the same as R⁵, X, and L² in the repeating unit represented by Formula (b), and the descriptions of the respective groups are also identical.

Wa in Formula (B) represents a group that interacts with metal ions except for a hydrophilic group represented by V described below or a precursor thereof. Among these, a cyano group and an ether group are preferred.

In Formula (C), R⁶'s each independently represent a hydrogen atom or a substituted or unsubstituted alkyl group.

In Formula (C), U represents a single bond or a substituted or unsubstituted divalent organic group. The definition of the divalent organic group is the same as the definition of the divalent organic group described regarding X, Y, and Z. U is preferably a single bond, an ester group (—COO—), an amide group (—CONH—), an ether group (—O—), or a substituted or unsubstituted divalent aromatic hydrocarbon group since it is easy to synthesize the polymer and the adhesiveness of the pattern-shaped metal layer is superior.

In Formula (C), L³ represents a single bond or a substituted or unsubstituted divalent organic group. The definition of the divalent organic group is the same as the definition of the divalent organic group described regarding L¹ and L². L³ is preferably a single bond, a divalent aliphatic hydrocarbon group, a divalent aromatic hydrocarbon group, or a group obtained by combining the above-described groups since it is easy to synthesize the polymer and the adhesiveness of the pattern-shaped metal layer is superior.

In Formula (C), V represents a hydrophilic group or a precursor thereof. The hydrophilic group is not particularly limited as long as the group is hydrophilic, and examples thereof include a hydroxyl group, a carboxylic acid group, and the like. In addition, the precursor of the hydrophilic group refers to a group that generates a hydrophilic group in the case of being treated in a predetermined manner (for example, treated with an acid or an alkali), and examples thereof include a carboxyl group protected by 2-tetrahydropyranyl group (THP) and the like.

The hydrophilic group is preferably an ionic polar group from the viewpoint of the interaction with metal ions. Specific examples of the ionic polar group include a carboxylic acid group, a sulfonic acid group, a phosphoric acid group, and a boronic acid group. Among these, a carboxylic acid group is preferred from the viewpoint of the appropriate acidity (that does not decompose other functional groups).

Preferred contents of the respective units in the second preferred aspect of the polymer are as described below.

The content of the repeating unit represented by Formula (A) is preferably 5 to 50 mol % and more preferably 5 to 30 mol % of the total repeating units in the polymer from the viewpoint of reactivity (the curing property and the polymerization property) and the suppression of gelation in the case of synthesis.

The content of the repeating unit represented by Formula (B) is preferably 5 to 75 mol % and more preferably 10 to 70 mol % of the total repeating units in the polymer from the viewpoint of the adsorption property to metal ions.

The content of the repeating unit represented by Formula (C) is preferably 10 to 70 mol %, more preferably 20 to 60 mol %, and still more preferably 30 to 50 mol % of the total repeating units in the polymer from the viewpoint of the developability using an aqueous solution and the moisture-resistant adhesiveness.

Specific examples of the polymer include the polymer described in Paragraphs [0106] to [0112] of JP2009-007540A, the polymer described in Paragraphs [0065] to [0070] of JP2006-135271A, the polymer described in Paragraphs [0030] to [0108] of US2010-080964A, and the like.

The polymer can be manufactured using a well-known method (for example, the method in the publications listed above).

(Preferred Aspect of Monomer)

In a case in which the compound is a so-called monomer, one example of a preferred aspect is a compound represented by Formula (X).

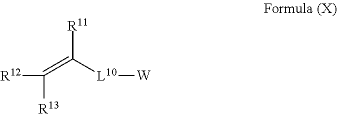

In Formula (X), R¹¹ to R¹³ each independently represent a hydrogen atom or a substituted or unsubstituted alkyl group. Examples of the unsubstituted alkyl group include a methyl group, an ethyl group, a propyl group, and a butyl group. In addition, examples of the substituted alkyl group include a methyl group, an ethyl group, a propyl group, and a butyl group which are substituted with a methoxy group, a chlorine atom, a bromine atom, a fluorine atom, and the like. Meanwhile, R¹¹ is preferably a hydrogen atom or a methyl group. R¹² is preferably a hydrogen atom. R¹³ is preferably a hydrogen atom.

L¹⁰ represents a single bond or a divalent organic group. Examples of the divalent organic group include substituted or unsubstituted aliphatic hydrocarbon groups (preferably having 1 to 8 carbon atoms), substituted or unsubstituted aromatic hydrocarbon groups (preferably having 6 to 12 carbon atoms), —O—, —S—, —SO₂—, —N(R)— (R: alkyl group), —CO—, —NH—, —COO—, —CONH—, groups obtained by combining the above-described groups (for example, an alkyleneoxy group, an alkyleneoxy carbonyl group, an alkylene carbonyloxy group, and the like), and the like.

The substituted or unsubstituted aliphatic hydrocarbon groups are preferably a methylene group, an ethylene group, a propylene group, a butylene group, and the above-described groups substituted with a methoxy group, a chlorine atom, a bromine atom, a fluorine atom, and the like.

The substituted or unsubstituted aromatic hydrocarbon groups are preferably an unsubstituted phenylene group or a phenylene group substituted with a methoxy group, a chlorine atom, a bromine atom, a fluorine atom, and the like.

In Formula (X), examples of a preferred aspect of L¹⁰ include —NH-aliphatic hydrocarbon group- and —CO-aliphatic hydrocarbon group-.

The definition of W is the same as the definition of W in Formula (b), and W represents the interactive group. The definition of the interactive group is as described above.

In Formula (X), a preferred aspect of W include ionic polar groups, and a carboxylic acid group is more preferred.

In a case in which the compound is a so-called monomer, one example of another preferred aspect is a compound represented by Formula (1).

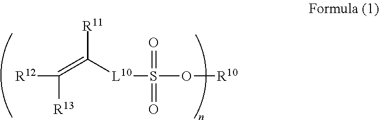

In Formula (1), R¹⁰ represents a hydrogen atom, a metal cation, or a quaternary ammonium cation. Examples of the metal cation include alkali metal cations (a sodium ion and a calcium ion), a copper ion, a palladium ion, a silver ion, and the like. Meanwhile, as the metal cation, mainly, a monovalent or divalent metal cation is used, and, in a case in which a divalent metal cation (for example, a palladium ion) is used, n described below represents two.

Examples of the quaternary ammonium cation include a tetramethylammonium ion, a tetrabutylammonium ion, and the like.

Among these, a hydrogen atom is preferred from the viewpoint of the attachment of metal ions and metal residues after patterning.

The definition of L¹⁰ in Formula (1) is the same as the definition of L¹⁰ in Formula (X), and L¹⁰ represents a single bond or a divalent organic group. The definition of the divalent organic group is as described above.

The definitions of R¹¹ to R¹³ in Formula (1) are the same as the definitions of R¹¹ to R¹³ in Formula (X), and R¹¹ to R¹³ represent hydrogen atoms or substituted or unsubstituted alkyl groups. Meanwhile, the preferred aspect of R¹¹ to R¹³ is as described above.

n represents an integer of one or two. Among these, n is preferably one from the viewpoint of the procurement of the compound.

Preferred aspects of the compound represented by Formula (1) include a compound represented by Formula (2).

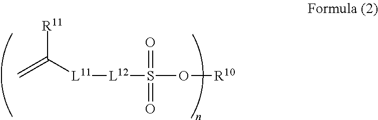

In Formula (2), R¹⁰, R¹¹, and n are the same as the above-described definitions.

L¹¹ represents an ester group (—COO—), an amide group (—CONH—), or a phenylene group. In a case in which L¹¹ is an amide group among these, the polymerization property and solvent resistance (for example, the alkali solvent resistance) of a plated layer to be obtained improve.

L¹² represents a single bond, a divalent aliphatic hydrocarbon group (preferably having 1 to 8 carbon atoms and more preferably having 3 to 5 carbon groups), or a divalent aromatic hydrocarbon group. The aliphatic hydrocarbon group may have a linear shape, a branched shape, or a cyclic shape. Meanwhile, in a case in which L¹² is a single bond, L¹¹ represents a phenylene group.

The molecular weight of the compound represented by Formula (1) is not particularly limited, but is preferably 100 to 1,000 and more preferably 100 to 300 from the viewpoint of the volatility, the solubility in solvents, the film-forming property, the handleability, and the like.

The content of the compound in the composition for forming, a plated layer is not particularly limited, but is preferably 2% to 50% by mass and more preferably 5% to 30% by mass of the total amount of the composition. In a case in which the content is in the above-described range, the handleability of the composition is excellent, and it is easy to control the layer thickness of the pattern-shaped plated layer.

To the composition for forming a plated layer, it is preferable to add a solvent from the viewpoint of handleability.

The solvent that can be used is not particularly limited, and examples thereof include water; alcohol-based solvents such as methanol, ethanol, propanol, ethylene glycol, 1-methoxy-2-propanol, glycerin, and propylene glycol monomethyl ether; acids such as acetic acid; ketone-based solvents such as acetone, methyl ethyl ketone, and cyclohexanone; amide-based solvents such as formamide, dimethylacetamide, and N-methyl pyrrolidone; nitrile-based solvents such as acetonitrile and propionitrile; ester-based solvents such as methyl acetate and ethyl acetate; carbonate-based solvents such as dimethyl carbonate and diethyl carbonate; additionally, ether-based solvents, glycol-based solvents, amine-based solvents, thiol-based solvents, halogen-based solvent, and the like.

Among these, alcohol-based solvents, amide-based solvents, ketone-based solvents, nitrile-based solvents, and carbonate-based solvents are preferred.

The content of the solvent in the composition for forming a plated layer is not particularly limited, but is preferably 50% to 98% by mass and more preferably 70% to 95% by mass of the total amount of the composition. In a case in which the content is in the above-described range, the handleability of the composition is excellent, and it is easy to control the layer thickness of the pattern-shaped plated layer.

To the composition for forming a plated layer, a polymerization initiator may be added. The addition of a polymerization initiator forms a larger number of bonds between compounds and between the compound and the substrate, and consequently, the pattern-shaped metal layer having superior adhesiveness can be obtained.

The polymerization initiator being used is not particularly limited, and, for example, a thermopolymerization initiator, a photopolymerization initiator, or the like can be used. Examples of the photopolymerization initiator include benzophenones, acetophenones, α-aminoalkyl phenones, benzoines, ketones, thioxanthones, benzyls, benzyl ketals, oxime esters, anthrones, tetramethylthiuram monosulfides, bisacylphosphinoxides, acylphosphineoxides, anthraquinones, azo compounds, and the like, and derivatives thereof.

In addition, examples of the thermopolymerization initiator include diazo-based compounds, peroxide-based compounds, and the like.

In a case in which the polymerization initiator is added to the composition for forming a plated layer, the content of the polymerization initiator is preferably 0.01% to 1% by mass and more preferably 0.1% to 0.5% by mass of the total amount of the composition. In a case in which the content is in the above-described range, the handleability of the composition is excellent, and the adhesiveness of the pattern-shaped metal layer to be obtained is superior.

To the composition for forming a plated layer, a monomer (except for the compound represented by Formula (X) or Formula (1)) may be added. The addition of a monomer enables the appropriate control of the crosslinking density and the like in the plated layer.

The monomer being used is not particularly limited, and examples thereof include compounds having an ethylenic unsaturated bond as an addition-polymerizable compound, compounds having an epoxy group as a ring-opening polymerizable compound, and the like. Among these, polyfunctional monomers are preferably used since the crosslinking density in the pattern-shaped plated layer improves and the adhesiveness of the pattern-shaped metal layer further improves. The polyfunctional monomer refers to a monomer having two or more polymerizable groups. Specifically, monomers having 2 to 6 polymerizable groups are preferably used.

From the viewpoint of the mobility of molecules during crosslinking reactions having an influence on reactivity, the molecular weight of the polyfunctional monomer being used is preferably 150 to 1,000 and more preferably 200 to 700. In addition, as the intervals (distances) among the plurality of polymerizable groups present, the number of atoms is preferably 1 to 15 and more preferably 6 or more and 10 or less.

To the composition for forming a plated layer, other additives (for example, a sensitizer, a curing agent, a polymerization inhibitor, an antioxidant, an antistatic agent, an ultraviolet absorbent, a filler, particles, a flame retardant, a surfactant, a lubricant, a plasticizer, and the like) may be added as necessary.

(Order of Step 1)

In Step 1, first, the composition for forming a plated layer is disposed on the substrate. The method therefor is not particularly limited, and examples thereof include a method in which the composition for forming a plated layer is brought into contact with the substrate, thereby forming a coating (a plated layer precursor layer) of the composition for forming a plated layer. Examples of this method include a method in which the composition for forming a plated layer is applied onto the substrate (coating method).

In the case of the coating method, the method for applying the composition for forming a plated layer onto the substrate is not particularly limited, and well-known methods (for example, spin coating, die coating, dip coating, and the like) can be used.

From the viewpoint of the handleability and the manufacturing efficiency, an aspect in which the composition for forming a plated layer is applied onto the substrate, and a drying treatment is carried out as necessary so as to remove the remaining solvent, thereby forming a coating is preferred.

Meanwhile, the conditions of the drying treatment are not particularly limited; however, from the viewpoint of superior productivity, the drying treatment is preferably carried out at room temperature to 220° C. (preferably 50° C. to 120° C.) for 1 to 30 minutes (preferably 1 to 10 minutes).

The method for imparting energy to the coating including the compound on the substrate in a pattern shape is not particularly limited. For example, a heating treatment, an exposure treatment (light irradiation treatment) or the like is preferably used, and an exposure treatment is preferred since the treatment ends within a short period of time. In a case in which energy is imparted to the coating, the polymerizable group in the compound is activated, the crosslinking among compounds is generated, and the curing of the layer proceeds.

As the exposure treatment, a UV lamp, light irradiation with visible light or the like, or the like is used. Examples of a light source include a mercury lamp, a metal halide lamp, a xenon lamp, a chemical lamp, a carbon arc lamp, and the like. Examples of radioactive rays include electron beams, X-rays, ion beams, infrared rays, and the like. Preferred examples of a specific aspect include scanning exposure using infrared lasers, high-illuminance flash exposure using xenon discharge lamps, infrared lamp exposure, and the like.

The exposure time varies depending on the reactivity of the compound and the light source, but is generally 10 seconds to 5 hours. The exposure energy needs to be approximately 10 to 8,000 mJ and is preferably in a range of 50 to 3,000 mJ.

Meanwhile, the method for carrying out the exposure treatment in a pattern shape is not particularly limited, well-known methods can be employed, and, for example, the coating may be irradiated with exposure light through a mask.

In addition, in a case in which a thermal treatment is used in order to impart energy, a blasting dryer, an oven, an infrared dryer, a heating drum, and the like can be used.

Next, portions in the coating to which energy is not imparted are removed, thereby forming a pattern-shaped plated layer.

The removal method is not particularly limited, and an optimal method is appropriately selected depending on compounds being used. Examples thereof include a method in which energy-non-imparted regions are removed using an alkaline solution (preferably pH: 13.0 to 13.8). In a case in which energy-non-imparted regions are removed using an alkaline solution, examples of the removal method include a method in which the substrate having the coating imparted with energy is immersed in the solution, a method in which a developer is applied onto the substrate, or the like, and the immersion method is preferred. In the case of the immersion method, the immersion time is preferably approximately 1 minute to 30 minutes from the viewpoint of productivity and workability.

In addition, examples of other methods include a method in which a solvent in which the compound dissolves is used as a developer and the substrate is immersed in the solvent.

(Pattern-Shaped Plated Layer)

The thickness of the pattern-shaped plated layer formed by the above-described treatments is not particularly limited, but is preferably 0.01 to 10 μm, more preferably 0.2 to 5 μm, and particularly preferably 0.3 to 3.0 μm from the viewpoint of productivity.

The pattern shape of the pattern-shaped plated layer is not particularly limited and is adjusted according to the place in which the pattern-shaped metal layer needs to be formed, and examples thereof include a mesh pattern and the like. Meanwhile, the shape of the grid is not particularly limited and may be a substantially rhombic shape or a polygonal shape (for example, a triangular shape, a square shape, or a hexagonal shape). In addition, the shape of the side may be, in addition to the straight shape, a curved shape or an arc shape.

[Step 2: Patter-Shaped Metal Layer-Forming Step]

Step 2 is a step of forming a pattern-shaped metal layer on the pattern-shaped plated layer by imparting metal ions to the pattern-shaped plated layer formed in Step 1 and carrying out a plating treatment on the pattern-shaped plated layer imparted with the metal ions. A pattern-shaped metal layer is disposed on the pattern-shaped plated layer by carrying out the present step.

Hereinafter, the step will be described in two divided parts of a step of imparting metal ions to the pattern-shaped plated layer (Step 2-1) and a step of carrying out a plating treatment on the pattern-shaped plated layer imparted with the metal ions (Step 2-2).

(Step 2-1: Metal Ion-Imparting Step)

In the present step, first, metal ions are imparted to the pattern-shaped plated layer. The interactive groups derived from the compound attach (adsorb) the imparted metal ions thereto according to their function. More specifically, metal ions are imparted in the plated layer and onto the surface of the plated layer.

The metal ion refers to an ion capable of serving as a plating catalyst in the case of being chemically reacted and, more specifically, turns into neutral metal, which is a plating catalyst, in the case of being reduced. In the present step, metal ions may be turned into a plating catalyst by imparting the metal ions to the pattern-shaped plated layer and then changing the metal ions into neutral metal by a separate reduction reaction before immersing the metal ions in a plating bath (for example, an electroless plating bath) or metal ions may be immersed in a plating bath and be changed into metal (plating catalyst) using a reduction agent in the plating bath.

The metal ions are preferably imparted to the pattern-shaped plated layer using a metal salt. The metal salt being used is not particularly limited as long as the metal salt is dissolved in an appropriate solvent and is dissociated into metal ions and bases (negative ions), and examples thereof include M(NO₃)ₙ, MCln, M_{2/n}(SO₄), M_{3/n}(PO₄) (M represents an n-valent metal atom), and the like. As the metal ions, metal ions obtained by dissociating the metal salt can be preferably used. Specific examples thereof include a Ag ion, a Cu ion, an Al ion, a Ni ion, a Co ion, a Fe ion, and a Pd ion, and, among these, ions capable of serving as a multidentate ligand are preferred, and particularly, a Ag ion and a Pd ion are preferred from the viewpoint of the number of kinds and catalyst capability of the functional group capable of serving as a ligand.

As the method for imparting the metal ions to the pattern-shaped plated layer, for example, the metal salt is dissolved in an appropriate solvent, a solution including dissociated metal ions is prepared, and the solution is applied onto the pattern-shaped plated layer or the substrate having the pattern-shaped plated layer formed therein is immersed in the solution.

As the solvent, water or an organic solvent is appropriately used. The organic solvent is preferably a solvent capable of intruding into the pattern-shaped plated layer, and, for example, acetone, methyl acetoacetate, ethyl acetoacetate, ethylene glycol diacetate, cyclohexanone, acetylacetone, acetophenone, 2-(1-cyclohexenyl)cyclohexanone, propylene glycol diacetate, triacetin, diethylene glycol diacetate, dioxane, N-methyl pyrrolidone, dimethyl carbonate, dimethyl cellosolve, and the like can be used.

The concentration of the metal ions in the solution is not particularly limited, but is preferably 0.001% to 50% by mass and more preferably 0.005% to 30% by mass.

In addition, the catalyzing time is preferably approximately 30 seconds to 24 hours and more preferably approximately 1 minute to 1 hour.

The amount of the metal ions adsorbed to the plated layer varies depending on the kind of the plating bath being used, the kind of the catalyst metal, the kind of the interactive group in the pattern-shaped plated layer, the operation method, and the like, but is preferably 5 to 1,000 mg/m², more preferably 10 to 800 mg/m², and particularly preferably 20 to 600 mg/m² from the viewpoint of the precipitation property of plating.

(Step 2-2: Plating Treatment Step)

Next, a plating treatment is carried out on the pattern-shaped plated layer imparted with the metal ions.

The plating treatment method is not particularly limited, and examples thereof include an electroless plating treatment and an electrolytic plating treatment (electroplating treatment). In the present step, it is possible to carry out only an electroless plating treatment or carry out an electroless plating treatment and then carry out an electrolytic plating treatment.

Meanwhile, in the present specification, a so-called silver mirror reaction can be considered as the above-described electroless plating treatment. For example, a desired pattern-shaped metal layer may be formed by reducing the attached metal ions using the silver mirror reaction or the like or, furthermore, an electrolytic plating treatment may be carried out after the formation of the pattern-shaped metal layer.

Hereinafter, the order of the electroless plating treatment and the electrolytic plating treatment will be described in detail.

The electroless plating treatment refers to an operation in which metal is precipitated by means of a chemical reaction using a solution obtained by dissolving metal ions that need to be precipitated as a plating.

The electroless plating treatment in the present step is carried out by, for example, washing the substrate including the pattern-shaped plated layer imparted with the metal ions with water so as to remove excessive metal ions and then immersing the substrate in an electroless plating bath. As the electroless plating bath being used, well-known electroless plating baths can be used. Meanwhile, in the electroless plating bath, the reduction of the metal ions and the subsequent non-electric plating are carried out.

Separately from an aspect in which the above-described electroless plating solution is used, the reduction of the metal ions in the pattern-shaped plated layer can also be carried out as a separate step before the electroless plating treatment by preparing a catalyst-activating solution (reduction solution). The catalyst-activating solution refers to a solution obtained by dissolving a reduction agent capable of reducing the metal ions to neutral metal, and the concentration of the reduction agent is preferably 0.1% to 50% by mass and more preferably 1% to 30% by mass of the entire solution. As the reduction agent, boron-based reduction agents such as sodium borohydride and dimethylamine boran or reduction agents such as formaldehyde and hypophosphorous acid can be used.

In the case of immersion, the substrate is preferably immersed under stirring or shaking.

As the composition of an ordinary electroless plating bath, in addition to a solvent (for example, water), 1. metal ions for plating, 2. a reduction agent, 3. an additive improving the stability of the metal ions (stabilizer) are mainly included. To this plating bath, additionally, well-known additives such as a plating bath stabilizer may be added.

The organic solvent that is used in the electroless plating bath needs to be a water-soluble solvent, and, from this viewpoint, ketones such as acetone and alcohols such as methanol, ethanol, and isopropanol are preferably used. As the kind of metals that are used in the electroless plating bath, copper, tin, lead, nickel, gold, silver, palladium, and rhodium are known, and, among these, from the viewpoint of electric conductivity, copper, silver, and gold are preferred, and copper is more preferred. In addition, optimal reduction agent and additives are selected according to the metals.

The immersion time in the electroless plating bath is preferably approximately 1 minute to 6 hours and more preferably approximately 1 minute to 3 hours.

The electrolytic plating treatment refers to an operation in which metal is precipitated by electric currents using a solution obtained by dissolving metal ions that need to be precipitated as a plating.

Meanwhile, as described above, in the present step, after the electroless plating treatment, the electrolytic plating treatment can be carried out as necessary. In the above-described aspect, it is possible to appropriately adjust the thickness of the pattern-shaped metal layer to be formed.

As the electrolytic plating method, it is possible to use well-known methods of the related art. Meanwhile, examples of metals that are used in the electrolytic plating include copper, chromium, lead, nickel, gold, silver, tin, zinc, and the like, and, from the viewpoint of electric conductivity, copper, silver, and gold are preferred, and copper is more preferred.

In addition, the film thickness of the pattern-shaped metal layer to be obtained by means of the electrolytic plating can be controlled by adjusting the concentration of metals included in the plating bath, the density of electric currents, and the like.

The thickness of the pattern-shaped metal layer formed in the above-described order is not particularly limited, and an appropriate thickness is selected depending on the intended use; however, from the viewpoint of electric conductive characteristics, the thickness is preferably 0.1 μm or more, preferably 0.5 μm or more, and more preferably 1 to 30 μm.

In addition, the kind of metal constituting the pattern-shaped metal layer is not particularly limited, and examples thereof include copper, chromium, lead, nickel, gold, silver, tin, zinc, and the like; however, from the viewpoint of the electric conductivity, copper, gold, and silver are preferred, and copper and silver are more preferred.

The pattern shape of the pattern-shaped metal layer is not particularly limited and is adjusted depending on the pattern shape of the pattern-shaped plated layer since the pattern-shaped metal layer is disposed on the pattern-shaped plated layer, and examples thereof include a mesh pattern and the like. The pattern-shaped metal layer having a mesh pattern is preferably applicable as a sensor electrode in touch panels.

Meanwhile, in the pattern-shaped plated layer on which the above-described treatments have been carried out, metal particles generated from the reduction of the metal ions are included. These metal particles are highly pure and distributed in the plated layer. In addition, as described above, a complicated shape is formed in the interface between the pattern-shaped plated layer and the pattern-shaped metal layer, and, due to the influence of this interface shape, the pattern-shaped metal layer appears darker.

In the present invention, a coating layer may be provided on the formed pattern-shaped metal layer. Particularly, in the case of a layer constitution in which the surface of the pattern-shaped metal layer is directly viewed, in a case in which the surface of the pattern-shaped metal layer is blacked (darkened), an effect of decreasing the metal gloss of the pattern-shaped metal layer and an effect of preventing copper color from becoming visible are obtained. Additionally, an antirust effect and a migration prevention effect are also obtained.

As the darkening method, there are a lamination method and a substitution method. Examples of the lamination method include a method in which a coating layer (darkening layer) is laminated using a plate called a well-known darkening plate, and NIKKA BLACK (manufactured by Nihon Kagaku Sanyo Co., Ltd.), EBONYCHROM 85 series (manufactured by Metal Finishing Laboratory Co., Ltd.), or the like can be used. In addition, examples of the substitution method include a method in which a coating layer (darkening layer) is produced by sulfurating or oxidizing the surface of the pattern-shaped metal layer and a method in which a coating layer (darkening layer) is produced by substituting the surface of the pattern-shaped metal layer with a more noble metal. As the sulfurating method, there are ENPLATE MB438A (manufactured by Meltex Inc.) and the like, and, as the oxidizing method, it is possible to use PROBOND80 (manufactured by Rohm and Haas Electronic Materials K.K.) and the like. As the substitution plate to noble metal, palladium can be used.

<Laminate>

By means of the above-described steps, an electrically conductive laminate including the substrate having two main surfaces, the pattern-shaped plated layer which is disposed on at least one main surface of the substrate and is formed by imparting energy to the composition for forming a plated layer in a pattern shape, and the pattern-shaped metal layer which is disposed on the pattern-shaped plated layer and is formed by carrying out the plating treatments is formed.

In the electrically conductive laminate, the pattern-shaped plated layer and the pattern-shaped metal layer may be disposed on only one main surface of the substrate, or the pattern-shaped plated layers and the pattern-shaped metal layers may be disposed on the two main surfaces of the substrate. Meanwhile, in a case in which the pattern-shaped plated layers and the pattern-shaped metal layers are disposed on both surfaces of the substrate, Step 1 and Step 2 need to be carried out on both surfaces of the substrate.

In the case of being used in the present invention, there are cases in which an overcoat layer, an optically transparent layer, and the like are adjacent thereto as adjacent layers, and, for the purpose of preventing the rusting of copper, linear alkyl dicarboxylic acids such as undecane diacid, dodecane diacid, and tridecane diacid, phosphoric acid ester compounds such as monomethyl phosphate and monoethyl phosphate, pyridine-based compounds such as quinaldic acid, triazole-based compounds such as triazole, carboxybenzotriazole, benzotriazole, and naphthol triazole, tetrasols such as 1H-tetrasol, bisphenol-based compounds such as 4,4′-butylidene bis-(6-tert-butyl-3-methylphenol), hindered phenol-based compounds such as pentaerythrityl tetrakis[3-(3,5-di-t-butyl-4-hydroxyphenyl)propionate], salicylic acid derivative-based compounds, hydrazide derivatives, aromatic phosphoric acid esters, thioureas, compounds having a mercapto group such as tolutriazole, 2-mercaptoxazole thiol, methyl benzothiazole, and mercaptothiazoline, and triazine ring compounds may be added to these adjacent layers.

In addition, cyclic compounds such as crown ethers and cyclic phosphorus compounds may be added to the adherent layers.

In addition, anionic surfactants such as alkylbenzene sulfonate, linear alkylbenzene sulfonate, naphthalene sulfonate, and alkenyl succinate, water-soluble macromolecules having a property as the Lewis base such as PVP, sulfonic acid group-containing polymers such as arylsulfonic acid/salt polymer, polystyrenesulfonate, polyallylsulfonate, polymethallylsulfonate, polyvinylsulfonate, polyisoprenesulfonate, acrylic acid-3-sulfopropyl homopolymers, methacrylic acid-3-sulfopropyl homopolymers, and 2-hydroxy-3-acrylamide propane sulfonate polymers may be added to the adherent layers.

In addition, antimony pentoxide hydrates, aluminum coupling agents, metal chelate compounds such as dizirconium alkoxide, zinc compounds, aluminum compounds, barium compounds, strontium compounds, and calcium compounds may be added to the adherent layers. Examples of the zinc compounds include zinc phosphate, zinc molybdate, zinc borate, zinc oxide, and the like. Examples of the aluminum compounds include aluminum dihydrogen triphosphate, aluminum phosphomolybdate, and the like. Examples of the barium compounds include barium metaborate and the like. Examples of the strontium compounds include strontium carbonate, strontium oxide, strontium acetate, strontium metaboarate, metal strontium, and the like. Examples of the calcium compounds include calcium phosphate and calcium molybdate.

In addition, oxidants such as ammonium peroxide, potassium peroxide, and hydrogen peroxide may be added to the adherent layers.

In addition, a combination of dichloroisocyanurate and sodium metasilicate pentahydrate may be added to the adherent layers.

Additionally, a well-known corrosion inhibitor of copper can be used. In addition, two or more kinds of these compounds may be used.

Corrosion may be prevented by coating the periphery of the pattern-shaped metal layer with the composition including these corrosion inhibitors of copper.

A primer layer may be further provided on the substrate. In a case in which a primer layer is disposed between the substrate and the pattern-shaped plated layer, adhesiveness between the substrate and the pattern-shaped plated layer further improves.

The thickness of the primer layer is not particularly limited; however, generally, is preferably 0.01 to 100 more preferably 0.05 to 20 and still more preferably 0.05 to 10 μm.

The material of the primer layer is not particularly limited, but is preferably a resin having favorable adhesiveness to the substrate. Specifically, the resin may be, for example, a thermosetting resin, a thermoplastic resin, or a mixture thereof, examples of the thermosetting resin include an epoxy resin, a phenol resin, a polyimide resin, a polyester resin, a bismaleimide resin, a polyolefin-based resin, an isocyanate-based resin, and the like. Examples of the thermoplastic resin include a phenoxy resin, polyether sulfone, polysulfone, polyphenylene sulfone, polyphenylene sulfide, polyphenyl ether, polyether imide, ABS resins, and the like.

Each of the thermoplastic resin and the thermosetting resin may be used singly or two kinds thereof may be jointly used. In addition, resins containing a cyano group may also be used, and, specifically, ABS resins and “the polymers including a unit having, a cyano group at a side chain” described in [0039] to [0063] of JP2010-84196A may also be used.

In addition, rubber components such as acrylonitrile-butadiene rubber (NBR rubber) and styrene-butadiene rubber (SBR rubber) can also be used.

Preferred aspects of the material constituting the primer layer include polymers having a conjugate diene compound unit to which hydrogen may be added. The conjugate diene compound unit refers to a repeating unit derived from a conjugate diene compound. The conjugate diene compound is not particularly limited as long as the compound has a molecular structure having two carbon-carbon double bonds which are isolated by one single bond.

Preferred aspects of the repeating unit derived from the conjugate diene compound include repeating units that are generated from a polymerization reaction of a compound having a butadiene skeleton.

To the conjugate diene compound unit, hydrogen may be added, and, in a case in which a hydrogen-added conjugate diene compound unit is included, the adhesiveness of the pattern-shaped metal layer further improves, which is preferable. That is, to the double bonds in the repeating unit derived from the conjugate diene compound, hydrogen may be added.

To the polymers having the conjugate diene compound unit to which hydrogen may be added, the above-described interactive group may also be added.

Preferred aspects of the polymer include acrylonitrile-butadiene rubber (NBR), carboxyl group-containing nitrile rubber (XNBR), acrylonitrile-butadiene-isoprene rubber (NBIR), acrylonitrile-butadiene-styrene copolymers (ABS resins), the above-described polymers to which hydrogen is added (for example, hydrogen-added acrylonitrile-butadiene rubber), and the like.

To the primer layer, other additives (for example, a sensitizer, an antioxidant, an antistatic agent, an ultraviolet absorbent, a filler, particles, a flame retardant, a surfactant, a lubricant, a plasticizer, and the like) may be added.

The method for forming the primer layer is not particularly limited, and examples thereof include a method in which a resin being used is laminated on the substrate, a method in which necessary components are dissolved in a solvent capable of dissolving the components and are applied and dried on the surface of the substrate using a method such as coating, and the like.

In the coating method, regarding the heating temperature and the time, conditions under which the coating solvent can be sufficiently dried may be selected, and, from the viewpoint of manufacturing suitability, heating conditions of a heating temperature of 200° C. or lower and a time in a range of 60 minutes or shorter are preferably selected, and heating conditions of a heating temperature of 40° C. to 100° C. and a time in a range of 20 minutes or shorter are more preferably selected. Meanwhile, as the solvent being used, an optimal solvent (for example, cyclohexane or methyl ethyl ketone) is appropriately selected depending on resins being used.

In a case in which a substrate on which the primer layer is disposed is used, a desired electrically conductive laminate can be obtained by carrying out Step 1 and Step 2 on the primer layer.

To the touch sensor 16, functional layers such as an antireflection layer may also be imparted.

[Calender Treatment]

The metal portions may be smoothened by carrying out a calender treatment. In this case, the electric conductivity of the metal portions significantly improves. The calender treatment can be carried out using a calender roll. A preferred aspect of the calender roll is generally a calender roll made up of a pair of rolls.

As the rolls that are used for the calender treatment, plastic rolls made of epoxy, polyimide, polyamide, polyimideamide, or the like or metal rolls are preferably used. Particularly, in a case in which emulsion layers are provided on both surfaces, the treatment is preferably carried out using metal rolls. In a case in which an emulsion layer is provided on a single surface, a combination of a metal roll and a plastic roll can be used from the viewpoint of wrinkle prevention. The lower limit value of the line pressure is 1,960 N/cm (200 kgf/cm, 699.4 kgf/cm² in the case of being converted to the surface pressure) or more and more preferably 2,940 N/cm (300 kgf/cm, 935.8 kgf/cm² in the case of being converted to the surface pressure) or more. The upper limit value of the line pressure is 6,880 N/cm (700 kgf/cm) or less.

The application temperature of a smoothing treatment represented by calender roll is preferably 10° C. (no temperature adjustment) to 100° C., and a more preferred temperature varies depending on the density of scanning or shape of metal mesh patterns or metal wiring, patterns or the kind of binders, but is approximately in a range of 10° C. (no temperature adjustment) to 50° C. 10° C. (no temperature adjustment) is a state in which the temperature is not adjusted.

Meanwhile, the present invention can be used in an appropriate combination with the techniques of the published unexamined patent applications and the international publication pamphlets shown in Table 1 and Table 2. Expressions such as “unexamined application”, “publication No.”, and “pamphlet No.” are not described.

TABLE 1

| | | | | |
|---|---|---|---|---|
| 2004-221564 | 2004-221565 | 2007-200922 | 2006-352073 | 2006-228469 |
| 2007-235115 | 2007-207987 | 2006-012935 | 2006-010795 | 2007-072171 |
| 2006-332459 | 2009-21153 | 2007-226215 | 2006-261315 | 2006-324203 |
| 2007-102200 | 2006-228473 | 2006-269795 | 2006-336090 | 2006-336099 |
| 2006-228478 | 2006-228836 | 2007-009326 | 2007-201378 | 2007-335729 |
| 2006-348351 | 2007-270321 | 2007-270322 | 2007-178915 | 2007-334325 |
| 2007-134439 | 2007-149760 | 2007-208133 | 2007-207883 | 2007-013130 |
| 2007-310091 | 2007-116137 | 2007-088219 | 2008-227351 | 2008-244067 |
| 2005-302508 | 2008-218784 | 2008-227350 | 2008-277676 | 2008-282840 |
| 2008-267814 | 2008-270405 | 2008-277675 | 2008-300720 | 2008-300721 |
| 2008-283029 | 2008-288305 | 2008-288419 | 2009-21334 | 2009-26933 |
| 2009-4213 | 2009-10001 | 2009-16526 | 2008-171568 | 2008-198388 |
| 2008-147507 | 2008-159770 | 2008-159771 | 2008-235224 | 2008-235467 |
| 2008-218096 | 2008-218264 | 2008-224916 | 2008-252046 | 2008-277428 |
| 2008-241987 | 2008-251274 | 2008-251275 | 2007-129205 | |

TABLE 2

| | | | | |
|---|---|---|---|---|
| 2006/001461 | 2006/088059 | 2006/098333 | 2006/098336 | 2006/098338 |
| 2006/098335 | 2006/098334 | 2007/001008 | | |

The present invention is, basically, constituted as described above. Hitherto, the touch sensor and the touch panel of the present invention have been described in detail, but the present invention is not limited to the above-described embodiments, and it is needless to say that a variety of improvements or modifications may be carried out within the scope of the gist of the present invention.

### EXPLANATION OF REFERENCES

10, 11: electronic device
10a, 22a, 92a, 94a: front surface
10b, 14b, 22b, 92b, 94b: rear surface
10c, 10d, 10e, 10f: side surface
12: chassis
12a, 23f, 23g: region
14: display panel
14a: display surface
16, 16a, 82, 82a to 82f: touch sensor
18: controller
20, 60, 80, 80a to 80f: touch panel
21, 21a: structure
22, 90: substrate
23a: planar region
23b, 23c, 23d, 23e: side surface region
24, 24a, 24b: touch sensor portion
25: circumferential edge
25a, 25b: boundary
26, 70: antenna
26a: meander dipole antenna (antenna)
27: corner portion
30: detection portion
32: peripheral wire portion
34a: first sensing electrode
34b: second sensing electrode
35: thin metal wire
36, 39: mesh pattern
36a: first terminal wire portion
36b: second terminal wire portion
37: cell
38a: first wire connection portion
38b: second wire connection portion
40a: first terminal portion
40b: second terminal portion
50: electric conductor
51: end portion
52, 76: power-feeding point
54, 56, 78: conductor
62: shield portion
64: conductive wire
72: main body portion
74: antenna element
84: through-hole
86: conductive layer
92: first support
94: second support
d: wire width

What is claimed is:

1. A touch sensor comprising:
a substrate having a plurality of regions that are at least a planar region and a side surface region which is continuous to the planar region and is bent with respect to the planar region;
a touch sensor portion provided in the planar region of the substrate; and
an antenna provided in a region other than the planar region of the substrate,
wherein the substrate is constituted of a flexible transparent substrate,
the touch sensor portion includes a detection portion and a peripheral wire portion, and
at least the detection portion is constituted of a thin metal wire.

2. The touch sensor according to claim 1,
wherein the antenna is provided in the side surface region.

3. The touch sensor according to claim 1,
wherein the substrate is provided with a shield portion that shields electromagnetic noise travelling toward at least one of the touch sensor portion or the antenna.

4. The touch sensor according to claim 2,
wherein the substrate is provided with a shield portion that shields electromagnetic noise travelling toward at least one of the touch sensor portion or the antenna.

5. The touch sensor according to claim 1,
wherein the substrate includes another planar region which is continuous to the planar region or the side surface region, and the shield portion that shields electromagnetic noise travelling toward at least one of the touch sensor portion or the antenna is provided in the another planar region.

6. The touch sensor according to claim 2,
wherein the substrate includes another planar region which is continuous to the planar region or the side surface region, and the shield portion that shields electromagnetic noise travelling toward at least one of the touch sensor portion or the antenna is provided in the another planar region.

7. The touch sensor according to claim 1,
wherein the touch sensor portion and the antenna are constituted of the same material.

8. The touch sensor according to claim 2,
wherein the touch sensor portion and the antenna are constituted of the same material.

9. The touch sensor according to claim 3,
wherein the touch sensor portion, the antenna, and the shield portion are constituted of the same material.

10. The touch sensor according to claim 5,
wherein the touch sensor portion, the antenna, and the shield portion are constituted of the same material.

11. The touch sensor according to claim 7,
wherein a surface resistance of the same material is 3 Ω/sq. or less.

12. The touch sensor according to claim 9,
wherein a surface resistance of the same material is 3 Ω/sq. or less.

13. The touch sensor according to claim 7,
wherein the same material is copper.

14. The touch sensor according to claim 9,
wherein the same material is copper.

15. The touch sensor according to claim 1,
wherein a width of the thin metal wire in the detection portion in the touch sensor portion is 5 μm or less and a pattern width in the antenna is 150 μm or more.

16. The touch sensor according to claim 2,
wherein a width of the thin metal wire in the detection portion in the touch sensor portion is 5 μm or less and a pattern width in the antenna is 150 μm or more.

17. The touch sensor according to claim 1,
wherein the detection portion in the touch sensor portion and the antenna are constituted of the thin metal wire, and the thin metal wire has a width of 5 μm or less.

18. The touch sensor according to claim 2,
wherein the detection portion in the touch sensor portion and the antenna are constituted of the thin metal wire, and the thin metal wire has a width of 5 μm or less.

19. A touch panel comprising:
the touch sensor according to claim 1.

20. A touch panel comprising:
the touch sensor according to claim 2.
